(19) United States
(12) Patent Application Publication
(10) Pub. No.: US 2024/0360329 A1
(43) Pub. Date: Oct. 31, 2024

(54) ORGANIC SLURRY FOR NEODYMIUM IRON BORON SCREEN PRINTING AND PREPARATION METHOD

(71) Applicants: GRIREM ADVANCED MATERIALS CO., LTD., Beijing (CN); GRIREM HI-TECH CO., LTD., Langfang (CN)

(72) Inventors: Xiaojun SUN, Beijing (CN); Yang LUO, Beijing (CN); Zilong WANG, Beijing (CN); Yan WANG, Beijing (CN); Jiping DUAN, Beijing (CN); Yuanfei YANG, Beijing (CN); Hongbin ZHANG, Beijing (CN); Kaiwen WU, Beijing (CN); Dunbo YU, Beijing (CN)

(73) Assignees: GRIREM ADVANCED MATERIALS CO., LTD., Beijing (CN); GRIREM HI-TECH CO., LTD., Langfang (CN)

(21) Appl. No.: 18/621,650

(22) Filed: Mar. 29, 2024

(30) Foreign Application Priority Data
Apr. 28, 2023 (CN) 202310478388.5

(51) Int. Cl. C09D 11/037

(52) U.S. Cl. CPC C09D 11/037

(57) ABSTRACT

Disclosed are an organic slurry for neodymium iron boron screen printing and a preparation method. The organic slurry includes a rare earth powder, an organic solvent, a resin, a dispersant, and/or a leveling agent, weight percentages of which are as follows: rare earth powder 50%-90%; organic solvent 8%-50%; resin 0.4%-6%; dispersant 0%-5%; and leveling agent 0%-3%. The preparation method includes: sequentially adding the weighed organic solvent, resin, dispersant, and/or leveling agent into a mixer, stirring at a constant temperature, and then cooling to room temperature to obtain an organic carrier; adding the organic carrier and the weighed rare earth powder into a vacuum high-speed disperser, and dispersing at a high speed to obtain a crude organic slurry; and transferring the crude organic slurry to a gap adjustable three-roll grinder, and grinding to obtain a fine organic slurry.

### CROSS-REFERENCE TO RELATED APPLICATIONS

This application claims priority to Chinese Patent Application No. 202310478388.5, filed on Apr. 28, 2023, the content of which is incorporated herein by reference in its entirety.

### TECHNICAL FIELD

The present application relates to the field of screen printing technology, in particular to an organic slurry for neodymium iron boron screen printing and a preparation method.

### BACKGROUND

Neodymium iron boron (NdFeB) permanent magnet materials have been widely used in many fields such as electronic information and medical industry since their discovery in the 1980s due to their excellent properties such as high residual magnetism, coercivity, and maximum magnetic energy product. In recent years, in order to meet the requirements of drive motors of new energy vehicles and direct drive permanent magnet units of wind driven generators for the properties of sintered neodymium iron boron magnets, grain boundary diffusion treatment is usually required for the magnets to improve their coercivity. Traditional grain boundary diffusion mostly uses heavy rare earth elements, fluorides, hydrides, oxides, alloys, and the like as diffusion sources, and uses sputtering, evaporation, electrophoresis, surface coating, impregnation, and the like to coat surfaces of magnets with the diffusion sources. The diffusion sources have low diffusion efficiency and high consumption, and lack a low-cost grain boundary diffusion process suitable for industrial large-scale stable production, which limits the development, application and promotion of high-end neodymium iron boron magnets.

In order to compensate for the shortcomings of existing grain boundary diffusion methods, screen printing technology has been applied in the neodymium iron boron industry. Screen printing depends on a silk screen perforated plate and a slurry which is scraped and printed onto a substrate through holes of the perforated plate. The screen printing integrates respective advantages of sputtering and surface coating methods, and has the characteristics of low cost, high production efficiency, easy implementation of automated production, and the like, so it is expected to develop into a mainstream process of neodymium iron boron grain boundary diffusion. As a raw material for screen printing, the slurry directly affects the printing and subsequent diffusion effects.

In existing technologies, the main method for producing a slurry is to disperse rare earth powder into an organic solution such as alcohol/acetone through stirring. Because the particle size of the powder is less than 10 microns, and the particles are prone to aggregation due to electrostatic attraction, surface tension, and the like between the particles, the organic slurry shows large particles, which are not conducive to the storage stability and printing uniformity of the organic slurry. In addition, traditional dispersion methods using only mixers for dispersion generally face problems such as poor dispersion effect, long time, and generation of a large number of bubbles, which seriously affect the properties of organic slurries and the quality of screen printing.

### SUMMARY

The present application aims to provide an organic slurry for neodymium iron boron screen printing and a preparation method, for solving at least one of the above technical problems. The prepared slurry has excellent dispersibility and stability and stable printing weight gain.

Embodiments of the present application are implemented as follows.

An organic slurry for neodymium iron boron screen printing includes a rare earth powder, an organic solvent, a resin, a dispersant, and/or a leveling agent, weight percentages of which are as follows:
rare earth powder 50%-90%;
organic solvent 8%-50%;
resin 0.4%-6%;
dispersant 0%-5%; and
leveling agent 0%-3%.

In a preferred embodiment of the present application, the rare earth powder in the organic slurry for neodymium iron boron screen printing includes one or two or more of a pure metal powder containing a heavy rare earth element, an alloy powder containing a heavy rare earth or light rare earth element, and a heavy rare earth powder of a hydride, a fluoride or an oxide containing heavy rare earth.

In a preferred embodiment of the present application, the heavy rare earth element in the organic slurry for neodymium iron boron screen printing includes one or two or more of Tb, Dy, Ho, and Gd.

The alloy powder is ReₓM_{y} in percentage by mass, wherein Re is one or two or more of Tb, Dy, Ho, Gd, Pr, Nd, La, Ce, and Y; M is one or two or more of Ga, Cu, Al, Ni, and Fe; 60%≤x≤95%, and 5%≤y≤40%.

In a preferred embodiment of the present application, the rare earth powder in the organic slurry for neodymium iron boron screen printing has a particle size D50<2 μm.

In a preferred embodiment of the present application, the organic solvent in the organic slurry for neodymium iron boron screen printing includes one or two or more of butyl carbitol, butyl carbitol acetate, N-methyl pyrrolidone, texanol, propylene glycol phenyl ether, propylene glycol methyl ether acetate, and DBE.

In a preferred embodiment of the present application, the resin in the organic slurry for neodymium iron boron screen printing includes one or two or more of polyvinylidene fluoride, nitrocellulose, ethyl cellulose, polyvinyl butyral, acrylic resin, polyester resin, and polyurethane.

Technical effects are as follows: by adding the resin, the viscosity of the organic slurry is increased to improve the dispersion and stability of the organic slurry, and the adhesion of the organic slurry to a substrate can be improved to ensure subsequent grain boundary diffusion effects.

In a preferred embodiment of the present application, the dispersant in the organic slurry for neodymium iron boron screen printing includes one or two or more of butyl acetate, modified polyurethane polymer, polyethylene glycol, polyvinyl pyrrolidone, and polyvinyl amide.

Technical effects are as follows: the dispersant can prevent re-aggregation of the rare earth powder in the organic slurry, reduce the fineness of the organic slurry, and improve the consistency of weight gain during screen printing.

In a preferred embodiment of the present application, the leveling agent in the organic slurry for neodymium iron boron screen printing includes one or two or more of organosilicon, acrylate, modified acrylic acid, and polyacrylic acid.

Technical effects are as follows: the leveling agent is particularly suitable for a high-viscosity organic slurry with high rare earth powder content/resin content to improve its leveling property and ensure uniform film thickness after screen printing.

In a preferred embodiment of the present application, the weight percentage of each ingredient in the organic slurry for neodymium iron boron screen printing is as follows: pure metal powder 60%-80%;
one or two or more of butyl carbitol, butyl carbitol acetate, and DBE 10%-30%;
one or two or more of ethyl cellulose, acrylic resin, and polyvinyl butyral 0.4%-5%;
one or two of polyethylene glycol and butyl acetate 0%-3%; and
one or more of acrylate, polyacrylic acid, and organosilicon 0%-1.5%.

In a preferred embodiment of the present application, the weight percentage of each ingredient in the organic slurry for neodymium iron boron screen printing is as follows:
alloy powder 60%-80%;
one or two or more of butyl carbitol, propylene glycol phenyl ether, and DBE 10%-30%;
one or two or more of polyester resin, ethyl cellulose, and acrylic resin 0.4%-3%;
one or two of polyethylene amide and polyvinyl pyrrolidone 0%-3%; and
one or two of modified acrylic acid and acrylate 0%-1.5%.

In a preferred embodiment of the present application, the weight percentage of each ingredient in the organic slurry for neodymium iron boron screen printing is as follows:
heavy rare earth powder 60%-80%;
one or two or more of butyl carbitol, butyl carbitol acetate, and propylene glycol phenyl ether 10%-30%;
one or two or more of polyvinyl butyral, ethyl cellulose, and polyurethane 0.4%-5%;
one or two of butyl acetate and polyethylene glycol 0%-3%; and
one or two of polyacrylic acid and acrylate 0%-1.5%.

A preparation method for the aforementioned organic slurry for neodymium iron boron screen printing includes:
weighing a rare earth powder, an organic solvent, a resin, a dispersant, and/or a leveling agent by weight percentage;
sequentially adding the weighed organic solvent, resin, dispersant, and/or leveling agent into a mixer, stirring at a constant temperature of 20-70° C. and a speed of 600 r/min-1200 r/min for 0.1-6 hours, and then cooling to room temperature to obtain an organic carrier, where
a technical effect is as follows: the prepared organic carrier is uniform and free of floccules;
adding the organic carrier and the weighed rare earth powder into a vacuum high-speed disperser, and dispersing at a high speed of 1000 r/min-4000 r/min for 0.25-1 hour to obtain a crude organic slurry, where
a technical effect is as follows: the prepared crude organic slurry has no bubbles and is uniformly dispersed; and
transferring the crude organic slurry to a gap adjustable three-roll grinder, and grinding 1-3 times to obtain a fine organic slurry.

A technical effect is as follows: the prepared fine organic slurry has a fineness of less than 2.5 μm.

The beneficial effects of the embodiments of the present application are as follows.

The prepared organic slurry for neodymium iron boron screen printing in the present application achieves high dispersibility and suspension stability by optimizing the organic carrier and dispersing agglomerated powder particles by virtue of strong mechanical actions of the vacuum high-speed disperser and the three-roll grinder through high-speed shearing and grinding. The prepared slurry has a fineness of less than 2.5 μm, a monthly sedimentation rate of less than 5%, and a consistency of weight gain of less than ±5% during printing. The prepared slurry has excellent dispersibility and stability.

### BRIEF DESCRIPTION OF THE DRAWINGS

In order to illustrate the technical solutions of the embodiments of the present application more clearly, the accompanying drawings required for use in the embodiments will be introduce briefly below. It should be understood that the following drawings show only some embodiments of the present application and should not be regarded as limiting the scope, and other relevant drawings can be derived based on the accompanying drawings by those of ordinary skill in the art without any creative efforts.

FIG. 1 is a schematic flowchart of a preparation method for an organic slurry for neodymium iron boron screen printing in the present application.

### DETAILED DESCRIPTION OF THE EMBODIMENTS

In order to make the objectives, technical solutions and advantages of the present application clearer, the following clearly and completely describes the technical solutions in the embodiments of the present application with reference to the accompanying drawings in the embodiments of the present application. Apparently, the described embodiments are some but not all of the embodiments of the present application. Generally, the components of the embodiments of the present application, described and shown in the accompanying drawings, can be arranged and designed with various different configurations.

An embodiment of the present application provides an organic slurry for neodymium iron boron screen printing, including a rare earth powder, an organic solvent, a resin, a dispersant, and/or a leveling agent, weight percentages of which are as follows:
rare earth powder 50%-90%;
organic solvent 8%-50%;
resin 0.4%-6%;
dispersant 0%-5%; and
leveling agent 0%-3%.

In a preferred embodiment of the present application, the rare earth powder in the organic slurry for neodymium iron boron screen printing includes one or two or more of a pure metal powder containing a heavy rare earth element, an alloy powder containing a heavy rare earth or light rare earth element, and a heavy rare earth powder of a hydride, a fluoride or an oxide containing heavy rare earth.

In a preferred embodiment of the present application, the heavy rare earth element in the organic slurry for neodymium iron boron screen printing includes one or two or more of Tb, Dy, Ho, and Gd.

The alloy powder is ReₓM_{y} in percentage by mass, where Re is one or two or more of Tb, Dy, Ho, Gd, Pr, Nd, La, Ce, and Y; M is one or two or more of Ga, Cu, Al, Ni, and Fe; 60%≤x≤95%, and 5%≤y≤40%.

In a preferred embodiment of the present application, the heavy rare earth element in the organic slurry for neodymium iron boron screen printing includes one or two of Tb and Dy.

The alloy powder is ReₓM_{y} in percentage by mass, where Re is one or two or more of Tb, Dy, Pr, and Nd. When Re is Tb, M is one or two or more of Ga, Cu, Al, and Ni, 70≤x≤90, and 10≤y≤30; when Re is Dy, M is one or two or more of Ni, Fe, and Ga, 60≤x≤80, and 20≤y≤40; and when Re is two or three of Tb, Pr, and Nd, M is one or two of Cu and Al, 80≤x≤95, and 5≤y≤20. The added alloy element can reduce the melting point of a diffusion source, change diffusion from solid-liquid diffusion to liquid-liquid diffusion, and significantly improve diffusion efficiency. And the alloy element diffused into a magnet is mostly distributed at a grain boundary to reduce magnetic exchange coupling between grains.

In a preferred embodiment of the present application, the rare earth powder in the organic slurry for neodymium iron boron screen printing has a particle size D50<2 μm.

Preferably, the particle size of the diffusion source powder is 1.6<D50<1.8. When the particle size of the powder is within the range, excellent stability can be obtained without a serious decrease in preparation efficiency of the powder due to a small particle size of the powder.

In a preferred embodiment of the present application, the organic solvent in the organic slurry for neodymium iron boron screen printing includes one or two or more of butyl carbitol, butyl carbitol acetate, N-methyl pyrrolidone, texanol, propylene glycol phenyl ether, propylene glycol methyl ether acetate, and DBE.

Preferably, the organic solvent is one or two or more of butyl carbitol, butyl carbitol acetate, propylene glycol phenyl ether, propylene glycol methyl ether acetate, and DBE. The organic solvent is highly volatile at a high temperature, thereby improving the drying efficiency after screen printing, reducing the entry of impurities such as C and O into the interior of the magnet during grain boundary diffusion, and ensuring the performance of the magnet after diffusion.

In a preferred embodiment of the present application, the resin in the organic slurry for neodymium iron boron screen printing includes one or two or more of polyvinylidene fluoride, nitrocellulose, ethyl cellulose, polyvinyl butyral, acrylic resin, polyester resin, and polyurethane.

Preferably, the resin is one or two or more of ethyl cellulose, polyvinyl butyral, and acrylic resin. The resin has a high molecular weight, can significantly increase the viscosity of the organic slurry by a small amount of addition, has a low degree of thermal decomposition, and reduces the entry of C and O elements into the magnet during the grain boundary diffusion.

Technical effects are as follows: by adding the resin, the viscosity of the organic slurry is increased to improve the dispersion and stability of the organic slurry, and the adhesion of the organic slurry to a substrate can be improved to ensure subsequent grain boundary diffusion effects.

In a preferred embodiment of the present application, the dispersant in the organic slurry for neodymium iron boron screen printing includes one or two or more of butyl acetate, modified polyurethane polymer, polyethylene glycol, polyvinyl pyrrolidone, and polyvinyl amide.

Preferably, the dispersant is one or two or more of polyethylene glycol, polyvinyl pyrrolidone, and polyethylene amide. The dispersant is easily soluble in the organic solvent, has good wetting property for the diffusion source powder, and is conducive to the dispersion of the diffusion source powder.

Technical effects are as follows: the dispersant can prevent re-aggregation of the rare earth powder in the organic slurry, reduce the fineness of the organic slurry, and improve the consistency of weight gain during screen printing.

In a preferred embodiment of the present application, the leveling agent in the organic slurry for neodymium iron boron screen printing includes one or two or more of organosilicon, acrylate, modified acrylic acid, and polyacrylic acid.

Preferably, the leveling agent is one or two or more of acrylate, modified acrylic acid, and polyacrylic acid. On the premise of ensuring high leveling property of the organic slurry, the leveling agent has a de-foaming effect due to its high molecular weight, thereby further improving the uniformity of screen printing.

Technical effects are as follows: the leveling agent is particularly suitable for a high-viscosity organic slurry with high rare earth powder content/resin content to improve its leveling property and ensure uniform film thickness after screen printing.

In a preferred embodiment of the present application, the weight percentage of each ingredient in the organic slurry for neodymium iron boron screen printing is as follows: pure metal powder 60%-80%;
one or two or more of butyl carbitol, butyl carbitol acetate, and DBE 10%-30%;
one or two or more of ethyl cellulose, acrylic resin, and polyvinyl butyral 0.4%-5%;
one or two of polyethylene glycol and butyl acetate 0%-3%; and
one or more of acrylate, polyacrylic acid, and organosilicon 0%-1.5%.

In a preferred embodiment of the present application, the weight percentage of each ingredient in the organic slurry for neodymium iron boron screen printing is as follows:
alloy powder 60%-80%;
one or two or more of butyl carbitol, propylene glycol phenyl ether, and DBE 10%-30%;
one or two or more of polyester resin, ethyl cellulose, and acrylic resin 0.4%-3%;
one or two of polyethylene amide and polyvinyl pyrrolidone 0%-3%; and
one or two of modified acrylic acid and acrylate 0%-1.5%.

In a preferred embodiment of the present application, the weight percentage of each ingredient in the organic slurry for neodymium iron boron screen printing is as follows:
heavy rare earth powder 60%-80%;
one or two or more of butyl carbitol, butyl carbitol acetate, and propylene glycol phenyl ether 10%-30%;
one or two or more of polyvinyl butyral, ethyl cellulose, and polyurethane 0.4%-5%;
one or two of butyl acetate and polyethylene glycol 0%-3%; and
one or two of polyacrylic acid and acrylate 0%-1.5%.

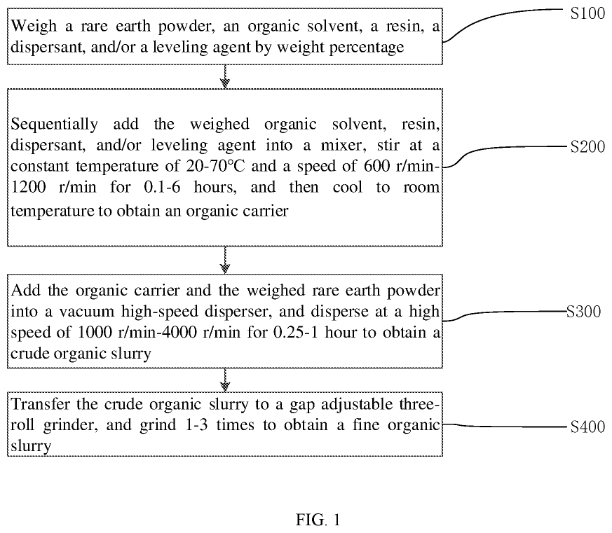

With reference to FIG. 1, a second embodiment of the present application provides a preparation method for the aforementioned organic slurry for neodymium iron boron screen printing, including:
S100: weighing a rare earth powder, an organic solvent, a resin, a dispersant, and/or a leveling agent by weight percentage;
S200: sequentially adding the weighed organic solvent, resin, dispersant, and/or leveling agent into a mixer, stirring at a constant temperature of 20-70° C. and a speed of 600 r/min-1200 r/min for 0.1-6 hours, and then cooling to room temperature to obtain an organic carrier, where a technical effect is as follows: the prepared organic carrier is uniform and free of floccules;
S300: adding the organic carrier and the weighed rare earth powder into a vacuum high-speed disperser, and dispersing at a high speed of 1000 r/min-4000 r/min for 0.25-1 hour to obtain a crude organic slurry, where a technical effect is as follows: the prepared crude organic slurry has no bubbles and is uniformly dispersed; and
S400: transferring the crude organic slurry to a gap adjustable three-roll grinder, and grinding 1-3 times to obtain a fine organic slurry.

A technical effect is as follows: the prepared fine organic slurry has a fineness of less than 2.5 μm.

Specifically, implementation effects of the present application will be further explained in detail through the following examples and comparative examples. Proportions of various ingredients in each example are shown in Table 1.

TABLE 1

| Serial | Rare earth | Organic | | | |
|---|---|---|---|---|---|
| number | powder | solvent | Resin | Dispersant | Leveling agent |
| 1 | 70% | 10% butyl | 3% ethyl | 2% polyvinyl | 2% modified |
| | Pr₇₀Cu₁₅Al₁₅ | carbitol + | cellulose | pyrrolidone | acrylic acid |
| | | 13% DBE | | | |
| 2 | 70% | 23% | 1% ethyl | 2% modified | 2% acrylate |
| | Pr₇₀Cu₁₅Al₁₅ | propylene | cellulose + 2% | polyurethane | |
| | | glycol phenyl | polyester resin | polymer | |
| | | ether | | | |
| 3 | 70% | 23% N- | 3% ethyl | 1% | 2% |
| | Tb₇₀Ni₃₀ | methyl | cellulose | polyethylene | organosilicon |
| | | pyrrolidone | | amide + 1% | |
| | | | | butyl acetate | |
| 4 | 70% | 23% N- | 3% ethyl | 2% | 2% |
| | Tb₈₀Cu₁₅Al₅ | methyl | cellulose | polyethylene | organosilicon |
| | | pyrrolidone | | amide | |
| 5 | 70% | 15% butyl | 3% | 2% | 2% polyacrylic |
| | Nd₆₀Fe₃₀Ga₁₀ | carbitol + 8% | polyurethane | polyethylene | acid |
| | | N-methyl | | amide | |
| | | pyrrolidone | | | |
| 6 | 30% DyH + | 23.5% | 3% polyester | 2% | 1.5% |
| | 40% TbH | propylene | resin | polyethylene | organosilicon |
| | | glycol phenyl | | glycol | |
| | | ether | | | |
| 7 | 70% | 23% butyl | 3% ethyl | 2% | 2% |
| | Tb₈₀Cu₁₅Al₅ | carbitol | cellulose | polyethylene | organosilicon |
| | | | | glycol | |
| 8 | 80% TbH | 17% butyl | 3% ethyl | 0% | 0% |
| | | carbitol | cellulose | | |
| 9 | 40% | 23% butyl | 3% | 2% butyl | 2% |
| | Tb₈₀Cu₁₅Al₅ + | carbitol | polyvinylidene | acetate | organosilicon |
| | 30% | acetate | fluoride | | |
| | Pr₇₀Cu₁₅Al₁₅ | | | | |
| 10 | 70% | 20% butyl | 3% ethyl | 2% butyl | 1% |
| | Tb₈₀Cu₁₅Al₅ | carbitol + 3% | cellulose | acetate | organosilicon + |
| | | DBE | | | 1% modified |
| | | | | | acrylic acid |
| 11 | 70% | 23% | 3% polyester | 2% | 2% |
| | Nd₆₀Fe₃₀Ga₁₀ | propylene | resin | polyethylene | organosilicon |
| | | glycol phenyl | | glycol | |
| | | ether | | | |
| 12 | 70% | 23% N- | 3% ethyl | 2% | 2% |
| | Nd₆₀Fe₃₀Ga₁₀ | methyl | cellulose | polyethylene | organosilicon |
| | | pyrrolidone | | amide | |
| 13 | 70% | 23% N- | 3% ethyl | 2% | 2% |
| | Tb₇₀Ni₃₀ | methyl | cellulose | polyethylene | organosilicon |
| | | pyrrolidone | | amide | |
| 14 | 70% | 26% butyl | 4% ethyl | 0% | 0% |
| | TbH | carbitol | cellulose | | |
| 15 | 70% | 15% butyl | 3% ethyl | 2% butyl | 2% |
| | Tb₇₀Ni₃₀ | carbitol + 8% | cellulose | acetate | organosilicon + |
| | | DBE | | | acrylate |
| 16 | 70% | 23% butyl | 1.5% | 1% modified | 1% |
| | DyO | carbitol | polyvinylidene | polyurethane | organosilicon + |
| | | acetate | fluoride + 0.5% | polymer + 1% | 1% modified |
| | | | polyester resin | butyl acetate + | acrylic acid |
| | | | | 1% | |
| | | | | polyethylene | |
| | | | | amide | |
| 17 | 30% DyH + | 22.5% | 3% polyester | 2% | 2.5% |
| | 40% TbH | propylene | resin | polyethylene | organosilicon |
| | | glycol phenyl | | glycol | |
| | | ether | | | |
| 18 | 70% Dy | 23% N- | 3% polyvinyl | 3% | 1% acrylate |
| | | methyl | butyral | polyethylene | |
| | | pyrrolidone | | glycol | |
| 19 | 70% | 10% butyl | 3% | 2% | 1% polyacrylic |
| | Pr₇₀Cu₁₅Al₁₅ | carbitol + | polyurethane | polyethylene | acid + 1% |
| | | 13% N- | | amide | acrylate |
| | | methyl | | | |
| | | pyrrolidone | | | |
| 20 | 30% DyH + | 23% | 3% polyester | 2% | 2% |
| | 40% TbH | propylene | resin | polyethylene | organosilicon |
| | | glycol phenyl | | glycol | |
| | | ether | | | |
| 21 | 70% | 15% butyl | 3% | 2% | 2% polyacrylic |
| | Tb₇₀Ni₃₀ | carbitol + 8% | polyurethane | polyethylene | acid |
| | | N-methyl | | amide | |
| | | pyrrolidone | | | |
| 22 | 70% Dy | 21% N- | 3% polyvinyl | 5% | 0.5% |
| | | methyl | butyral | polyethylene | organosilicon + |
| | | pyrrolidone | | glycol | 0.5% |
| | | | | | polyacrylic |
| | | | | | acid |
| 23 | 40% | 23% butyl | 3% | 1.5% butyl | 2% |
| | Tb₈₀Cu₁₅Al₅ + | carbitol | polyvinylidene | acetate + 0.5% | organosilicon |
| | 30% | acetate | fluoride | polyethylene | |
| | Pr₇₀Cu₁₅Al₁₅ | | | glycol | |
| 24 | 70% | 23% N- | 3% polyvinyl | 2% | 2% |
| | Tb₈₀Cu₁₅Al₅ | methyl | butyral | polyethylene | organosilicon |
| | | pyrrolidone | | glycol | |
| 25 | 70% DyO | 23% butyl | 1.5% | 2% butyl | 2% |
| | | carbitol | polyvinylidene | acetate | organosilicon |
| | | acetate | fluoride + + | | |
| | | | 1.5% | | |
| | | | polyester resin | | |
| 26 | 70% Dy | 22% N- | 3% polyvinyl | 4% | 0.5% |
| | | methyl | butyral | polyethylene | organosilicon + + |
| | | pyrrolidone | | glycol | 0.5% |
| | | | | | modified |
| | | | | | acrylic acid |
| 27 | 71% | 15% butyl | 1.5% | 2% | 2% polyacrylic |
| | Tb₇₀Ni₃₀ | carbitol + 8% | polyurethane + | polyethylene | acid |
| | | N-methyl | 1.5% ethyl | amide | |
| | | pyrrolidone | cellulose | | |
| 28 | 70% | 23% N- | 3% ethyl | 1% | 2% |
| | Tb₇₀Ni₃₀ | methyl | cellulose | polyethylene | organosilicon |
| | | pyrrolidone | | amide + 0.5% | |
| | | | | modified | |
| | | | | polyurethane | |
| | | | | polymer + | |
| | | | | 0.5% butyl | |
| | | | | acetate | |
| 29 | 70% TbF | 24% butyl | 4% | 1% butyl | 1% |
| | | carbitol | polyvinylidene | acetate | organosilicon |
| | | acetate | fluoride | | |
| 30 | 70% | 20% butyl | 3% ethyl | 2% | 2% |
| | Tb₈₀Cu₁₅Al₅ | carbitol + 3% | cellulose | polyethylene | organosilicon |
| | | DBE | | amide | |
| 31 | 70% TbF | 25% butyl | 3% | 1% | 1% |
| | | carbitol | polyvinylidene | polyethylene | organosilicon |
| | | acetate | fluoride | amide | |
| 32 | 70% | 23% N- | 1% polyvinyl | 2% | 2% |
| | Pr₇₀Cu₁₅Al₁₅ | methyl | butyral + 2% | polyethylene | organosilicon |
| | | pyrrolidone | ethyl cellulose | amide | |
| 33 | 70% TbF | 22% butyl | 6% | 1% | 1% |
| | | carbitol | polyvinylidene | polyethylene | organosilicon |
| | | acetate | fluoride | amide | |
| 34 | 70% | 23% butyl | 3% | 2% | 2% |
| | Tb₈₀Cu₁₅Al₅ | carbitol | polyvinylidene | polyethylene | organosilicon |
| | | acetate | fluoride | glycol | |
| 35 | 70% | 23% N- | 2% ethyl | 1.5% | 2% |
| | Nd₆₀Fe₃₀Ga₁₀ | methyl | cellulose + + | polyethylene | organosilicon |
| | | pyrrolidone | 1% polyester | amide + 0.5% | |
| | | | resin | modified | |
| | | | | polyurethane | |
| | | | | polymer | |
| 36 | 70% | 23% butyl | 3% | 2% butyl | 2% |
| | Tb₇₀Ni₃₀ | carbitol | polyvinylidene | acetate | organosilicon |
| | | acetate | fluoride | | |
| 37 | 70% TbF | 27.6% butyl | 0.4% | 0.5% | 1% |
| | | carbitol | polyvinylidene | polyethylene | organosilicon |
| | | acetate | fluoride | amide + 0.5% | |
| | | | | polyethylene | |
| | | | | glycol | |
| 38 | 70% DyO | 10% butyl | 3% ethyl | 2% polyvinyl | 2% polyacrylic |
| | | carbitol + | cellulose | pyrrolidone | acid |
| | | 13% DBE | | | |
| 39 | 70% Dy | 25% N- | 3% polyvinyl | 1% | 1% modified |
| | | methyl | butyral | polyethylene | acrylic acid |
| | | pyrrolidone | | glycol | |
| 40 | 70% | 23% | 3% polyester | 2% | 2% |
| | Tb₇₀Ni₃₀ | propylene | resin | polyethylene | organosilicon |
| | | glycol phenyl | | glycol | |
| | | ether | | | |
| 41 | 30% DyH + | 24% | 3% polyester | 2% | 0.5% |
| | 40% TbH | propylene | resin | polyethylene | organosilicon + |
| | | glycol phenyl | | glycol | 0.5% |
| | | ether | | | polyacrylic |
| | | | | | acid |
| 42 | 30% DyH + | 25% | 3% polyester | 2% | 0% |
| | 40% TbH | propylene | resin | polyethylene | organosilicon |
| | | glycol phenyl | | glycol | |
| | | ether | | | |
| 43 | 70% | 15% butyl | 3% ethyl | 1.5% butyl | 1% |
| | Tb₇₀Ni₃₀ | carbitol + 8% | cellulose | acetate + 0.5% | organosilicon + |
| | | DBE | | polyethylene | 1% acrylate |
| | | | | glycol | |
| 44 | 70% | 15% butyl | 3% ethyl | 2% butyl | 1% |
| | Nd₆₀Fe₃₀Ga₁₀ | carbitol + 8% | cellulose | acetate | organosilicon + |
| | | DBE | | | 1% modified |
| | | | | | acrylic acid |
| 45 | 70% | 10% butyl | 3% | 2% | 1% polyacrylic |
| | Pr₇₀Cu₁₅Al₁₅ | carbitol + 7% | polyurethane | polyethylene | acid + 1% |
| | | DBE + 6% | | amide | acrylate |
| | | N-methyl | | | |
| | | pyrrolidone | | | |
| 46 | 40% | 15% butyl | 3% ethyl | 2% butyl | 2% acrylate |
| | Tb₈₀Cu₁₅Al₅ + | carbitol + 8% | cellulose | acetate | |
| | 30% | DBE | | | |
| | Pr₇₀Cu₁₅Al₁₅ | | | | |
| 47 | 70% | 23% N- | 3% polyvinyl | 2% | 2% |
| | Pr₇₀Cu₁₅Al₁₅ | methyl | butyral | polyethylene | organosilicon |
| | | pyrrolidone | | amide | |
| 48 | 40% | 15% butyl | 3% | 2% | 2% polyacrylic |
| | Tb₈₀Cu₁₅Al₅ + | carbitol + 8% | polyurethane | polyethylene | acid |
| | 30% | N-methyl | | amide | |
| | Pr₇₀Cu₁₅Al₁₅ | pyrrolidone | | | |
| 49 | 70% | 23% N- | 1% polyvinyl | 2% | 2% |
| | Pr₇₀Cu₁₅Al₁₅ | methyl | butyral + 1% | polyethylene | organosilicon |
| | | pyrrolidone | ethyl cellulose + | amide | |
| | | | 1% | | |
| | | | polyurethane | | |
| 50 | 70% TbF | 27% butyl | 1% | 1% polyvinyl | 1% |
| | | carbitol | polyvinylidene | pyrrolidone | organosilicon |
| | | acetate | fluoride | | |
| 51 | 70% Dy | 26% N- | 3% polyvinyl | 0% | 1% polyacrylic |
| | | methyl | butyral | polyethylene | acid |
| | | pyrrolidone | | glycol | |
| 52 | 70% TbF | 26% butyl | 2% | 1% modified | 1% |
| | | carbitol | polyvinylidene | polyurethane | organosilicon |
| | | acetate | fluoride | polymer | |
| 53 | 50% TbH | 44% butyl | 6% ethyl | 0% | 0% |
| | | carbitol | cellulose | | |
| 54 | 70% DyO | 23% butyl | 3% | 2% butyl | 1% |
| | | carbitol | polyvinylidene | acetate | organosilicon + |
| | | acetate | fluoride | | 1% acrylate |
| 55 | 30% DyH + | 23% | 3% polyester | 2% | 2% |
| | 40% TbH | propylene | resin | polyethylene | organosilicon |
| | | glycol phenyl | | glycol | |
| | | ether | | | |
| 56 | 70% Dy | 24% N- | 3% polyvinyl | 2% | 1% |
| | | methyl | butyral | polyethylene | organosilicon |
| | | pyrrolidone | | glycol | |
| 57 | 70% | 23% butyl | 3% | 2% butyl | 2% |
| | Pr₇₀Cu₁₅Al₁₅ | carbitol | polyvinylidene | acetate | organosilicon |
| | | acetate | fluoride | | |
| 58 | 70% DyO | 23% butyl | 1.5% | 1.5% butyl | 2% |
| | | carbitol | polyvinylidene | acetate + 0.5% | organosilicon |
| | | acetate | fluoride + + | polyethylene | |
| | | | 1.5% | amide | |
| | | | polyester resin | | |
| 59 | 30% DyH + | 24.5% | 3% polyester | 2% | 0.5% |
| | 40% TbH | propylene | resin | polyethylene | organosilicon |
| | | glycol phenyl | | glycol | |
| | | ether | | | |
| 60 | 70% DyO | 10% butyl | 3% | 2% | 1% acrylate + |
| | | carbitol + | polyurethane | polyethylene | 1% polyacrylic |
| | | 13% N- | | amide | acid |
| | | methyl | | | |
| | | pyrrolidone | | | |
| 61 | 40% | 23% butyl | 1.5% | 2% butyl | 2% |
| | Tb₈₀Cu₁₅Al₅ + | carbitol | polyvinylidene | acetate | organosilicon |
| | 30% | acetate | fluoride + 1.5% | | |
| | Pr₇₀Cu₁₅Al₁₅ | | ethyl cellulose | | |
| 62 | 90% TbH | 8% butyl | 2% ethyl | 0% | 0% |
| | | carbitol | cellulose | | |
| 63 | 70% | 23% | 3% polyester | 2% modified | 2% acrylate |
| | Pr₇₀Cu₁₅Al₁₅ | propylene | resin | polyurethane | |
| | | glycol phenyl | | polymer | |
| | | ether | | | |
| 64 | 70% DyO | 10% butyl | 3% | 2% | 2% acrylate |
| | | carbitol + 8% | polyurethane | polyethylene | |
| | | DBE + 5% | | amide | |
| | | N-methyl | | | |
| | | pyrrolidone | | | |

### Example 1

70% of Pr70Cu15Al15 metal powder, 10% of butyl carbitol, 13% of DBE, 3% of ethyl cellulose, 2% of polyvinyl pyrrolidone, and 2% of modified acrylic acid were weighed by weight percentage, where the metal powder had a particle size D50 of 1.67 μm.

The butyl carbitol, DBE, ethyl cellulose, polyvinyl pyrrolidone, and modified acrylic acid were sequentially added into a mixer and stirred at a constant temperature of 25° C. and a speed of 1200 r/min for 15 minutes to obtain a uniform and non-flocculent organic carrier.

The Pr₇₀Cu₁₅Al₁₅ metal powder and the prepared organic carrier were added into a vacuum high-speed disperser and dispersed at a high speed of 3000 r/min for 60 minutes to preliminarily prepare an organic slurry; and then the organic slurry obtained by the high-speed dispersion was transferred to a three-roll grinder and ground once to obtain an organic slurry having a fineness of less than 2.3 μm.

### Example 2

70% of Pr₇₀Cu₁₅Al₁₅ metal powder, 23% of propylene glycol phenyl ether, 2% of ethyl cellulose, 1% of polyester resin, 2% of modified polyurethane polymer, and 2% of acrylate were weighed by weight percentage, where the metal powder had a particle size D50 of 1.86 μm.

The propylene glycol phenyl ether, ethyl cellulose, polyester resin, modified polyurethane polymer, and acrylate were sequentially added into a mixer and stirred at a constant temperature of 60° C. and a speed of 1200 r/min for 6 hours to obtain a uniform and non-flocculent organic carrier.

The Pr₇₀Cu₁₅Al₁₅ metal powder and the prepared organic carrier were added into a vacuum high-speed disperser and dispersed at a high speed of 3000 r/min for 60 minutes to preliminarily prepare an organic slurry; and then the organic slurry obtained by the high-speed dispersion was transferred to a three-roll grinder and ground once to obtain an organic slurry having a fineness of less than 2.2 μm.

### Example 3

70% of Tb₇₀Ni₃₀ metal powder, 23% of N-methyl pyrrolidone, 3% of ethyl cellulose, 1% of polyethylene amide, 1% of butyl acetate, and 2% of organosilicon were weighed by weight percentage, where the metal powder had a particle size D50 of 1.8 μm.

The N-methyl pyrrolidone, ethyl cellulose, polyethylene amide, butyl acetate, and organosilicon were sequentially added into a mixer and stirred at a constant temperature of 25° C. and a speed of 1200 r/min for 15 minutes to obtain a uniform and non-flocculent organic carrier.

The Tb₇₀Ni₃₀ metal powder and the prepared organic carrier were added into a vacuum high-speed disperser and dispersed at a high speed of 3000 r/min for 60 minutes to preliminarily prepare an organic slurry; and then the organic slurry obtained by the high-speed dispersion was transferred to a three-roll grinder and ground three times to obtain an organic slurry having a fineness of less than 1.9 μm.

### Example 4

70% of Tb₈₀Cu₁₅Al₅ metal powder, 23% of N-methyl pyrrolidone, 3% of ethyl cellulose, 2% of polyethylene amide, and 2% of organosilicon were weighed by weight percentage, where the metal powder had a particle size D50 of 1.94 μm.

The N-methyl pyrrolidone, ethyl cellulose, polyethylene amide, and organosilicon were sequentially added into a mixer and stirred at a constant temperature of 25° C. and a speed of 1200 r/min for 15 minutes to obtain a uniform and non-flocculent organic carrier.

The Tb₈₀Cu₁₅Al₅ metal powder and the prepared organic carrier were added into a vacuum high-speed disperser and dispersed at a high speed of 3000 r/min for 60 minutes to preliminarily prepare an organic slurry; and then the organic slurry obtained by the high-speed dispersion was transferred to a three-roll grinder and ground twice to obtain an organic slurry having a fineness of less than 2.3 μm.

### Example 5

70% of Nd₆₀Fe₃₀Ga₁₀ metal powder, 15% of butyl carbitol, 8% of N-methyl pyrrolidone, 3% of polyurethane, 2% of polyethylene amide, and 2% of polyacrylic acid were weighed by weight percentage, where the metal powder had a particle size D50 of 1.99 μm.

The butyl carbitol, N-methyl pyrrolidone, polyurethane, polyethylene amide, and polyacrylic acid were sequentially added into a mixer and stirred at a constant temperature of 25° C. and a speed of 1200 r/min for 15 minutes to obtain a uniform and non-flocculent organic carrier.

The Nd₆₀Fe₃₀Ga₁₀ metal powder and the prepared organic carrier were added into a vacuum high-speed disperser and dispersed at a high speed of 2500 r/min for 60 minutes to preliminarily prepare an organic slurry; and then the organic slurry obtained by the high-speed dispersion was transferred to a three-roll grinder and ground three times to obtain an organic slurry having a fineness of less than 2.5 μm.

### Example 6

30% of DyH+40% of TbH metal powders, 23.5% of propylene glycol phenyl ether, 3% of polyester resin, 2% of polyethylene glycol, and 1.5% of organosilicon were weighed by weight percentage, where the metal powders had a particle size D50 of 1.71 μm.

The propylene glycol phenyl ether, polyester resin, polyethylene glycol, and organosilicon were sequentially added into a mixer and stirred at a constant temperature of 60° C. and a speed of 1200 r/min for 6 hours to obtain a uniform and non-flocculent organic carrier.

The 30% of DyH+40% of TbH metal powders and the prepared organic carrier were added into a vacuum high-speed disperser and dispersed at a high speed of 2300 r/min for 30 minutes to preliminarily prepare an organic slurry; and then the organic slurry obtained by the high-speed dispersion was transferred to a three-roll grinder and ground three times to obtain an organic slurry having a fineness of less than 1.8 μm.

### Example 7

70% of Tb₈₀Cu₁₅Al₅ metal powder, 23% of butyl carbitol, 3% of ethyl cellulose, 2% of polyethylene glycol, and 2% of organosilicon were weighed by weight percentage, where the metal powder had a particle size D50 of 1.87 μm.

The butyl carbitol, ethyl cellulose, polyethylene glycol, and organosilicon were sequentially added into a mixer and stirred at a constant temperature of 25° C. and a speed of 1200 r/min for 15 minutes to obtain a uniform and non-flocculent organic carrier.

The Tb₈₀Cu₁₅Al₅ metal powder and the prepared organic carrier were added into a vacuum high-speed disperser and dispersed at a high speed of 3500 r/min for 60 minutes to preliminarily prepare an organic slurry; and then the organic slurry obtained by the high-speed dispersion was transferred to a three-roll grinder and ground twice to obtain an organic slurry having a fineness of less than 2.5 μm.

### Example 8

80% of TbH metal powder, 17% of butyl carbitol, and 3% of ethyl cellulose were weighed by weight percentage, where the TbH metal powder had a particle size D50 of 1.96 μm.

The butyl carbitol and the ethyl cellulose were sequentially added into a mixer and stirred at a constant temperature of 25° C. and a speed of 1000 r/min for 15 minutes to obtain a uniform and non-flocculent organic carrier.

The TbH metal powder and the prepared organic carrier were added into a vacuum high-speed disperser and dispersed at a high speed of 3000 r/min for 40 minutes to preliminarily prepare an organic slurry; and then the organic slurry obtained by the high-speed dispersion was transferred to a three-roll grinder and ground three times to obtain an organic slurry having a fineness of less than 2.5 μm.

### Example 9

40% of Tb₈₀Cu₁₅Al₅+30% of Pr₇₀Cu₁₅Al₁₅ metal powders, 23% of butyl carbitol acetate, 3% of polyvinylidene fluoride, 2% of butyl acetate, and 2% of organosilicon were weighed by weight percentage, where the metal powders had particle sizes D50 of 1.82 μm and 1.79 μm, respectively.

The butyl carbitol acetate, polyvinylidene fluoride, butyl acetate, and organosilicon were sequentially added into a mixer and stirred at a constant temperature of 40° C. and a speed of 1200 r/min for 40 minutes to obtain a uniform and non-flocculent organic carrier.

The Tb₈₀Cu₁₅Al₅ and Pr₇₀Cu₁₅Al₁₅ metal powders and the prepared organic carrier were added into a vacuum high-speed disperser and dispersed at a high speed of 3500 r/min for 60 minutes to preliminarily prepare an organic slurry; and then the organic slurry obtained by the high-speed dispersion was transferred to a three-roll grinder and ground twice to obtain an organic slurry having a fineness of less than 2.5 μm.

### Example 10

70% of Tb₈₀Cu₁₅Al₅ metal powder, 20% of butyl carbitol, 3% of DBE, 3% of ethyl cellulose, 2% of butyl acetate, 1% of organosilicon, and 1% of modified acrylic acid were weighed by weight percentage, where the metal powder had a particle size D50 of 1.98 μm.

The butyl carbitol, DBE, ethyl cellulose, butyl acetate, organosilicon, and modified acrylic acid were sequentially added into a mixer and stirred at a constant temperature of 25° C. and a speed of 1200 r/min for 15 minutes to obtain a uniform and non-flocculent organic carrier.

The Tb₈₀Cu₁₅Al₅ metal powder and the prepared organic carrier were added into a vacuum high-speed disperser and dispersed at a high speed of 3000 r/min for 60 minutes to preliminarily prepare an organic slurry; and then the organic slurry obtained by the high-speed dispersion was transferred to a three-roll grinder and ground three times to obtain an organic slurry having a fineness of less than 2.3 μm.

### Example 11

70% of Nd₆₀Fe₃₀Ga₁₀ metal powder, 23% of propylene glycol phenyl ether, 3% of polyester resin, 2% of polyethylene glycol, and 2% of organosilicon were weighed by weight percentage, where the metal powder had a particle size D50 of 1.83 μm.

The propylene glycol phenyl ether, polyester resin, polyethylene glycol, and organosilicon were sequentially added into a mixer and stirred at a constant temperature of 60° C. and a speed of 1200 r/min for 6 hours to obtain a uniform and non-flocculent organic carrier.

The Nd₆₀Fe₃₀Ga₁₀ metal powder and the prepared organic carrier were added into a vacuum high-speed disperser and dispersed at a high speed of 2500 r/min for 60 minutes to preliminarily prepare an organic slurry; and then the organic slurry obtained by the high-speed dispersion was transferred to a three-roll grinder and ground once to obtain an organic slurry having a fineness of less than 2.4 μm.

### Example 12

70% of Nd₆₀Fe₃₀Ga₁₀ metal powder, 23% of N-methyl pyrrolidone, 3% of ethyl cellulose, 2% of polyethylene amide, and 2% of acrylate were weighed by weight percentage, where the metal powder had a particle size D50 of 1.56 μm.

The N-methyl pyrrolidone, ethyl cellulose, polyethylene amide, and acrylate were sequentially added into a mixer and stirred at a constant temperature of 25° C. and a speed of 1200 r/min for 15 minutes to obtain a uniform and non-flocculent organic carrier.

The Nd₆₀Fe₃₀Ga₁₀ metal powder and the prepared organic carrier were added into a vacuum high-speed disperser and dispersed at a high speed of 2500 r/min for 60 minutes to preliminarily prepare an organic slurry; and then the organic slurry obtained by the high-speed dispersion was transferred to a three-roll grinder and ground three times to obtain an organic slurry having a fineness of less than 1.7 μm.

### Example 13

70% of Tb₇₀Ni₃₀ metal powder, 23% of N-methyl pyrrolidone, 3% of ethyl cellulose, 2% of polyethylene amide, and 2% of organosilicon were weighed by weight percentage, where the metal powder had a particle size D50 of 1.75 μm.

The N-methyl pyrrolidone, ethyl cellulose, polyethylene amide, and organosilicon were sequentially added into a mixer and stirred at a constant temperature of 25° C. and a speed of 1200 r/min for 15 minutes to obtain a uniform and non-flocculent organic carrier.

The Tb₇₀Ni₃₀ metal powder and the prepared organic carrier were added into a vacuum high-speed disperser and dispersed at a high speed of 3000 r/min for 60 minutes to preliminarily prepare an organic slurry; and then the organic slurry obtained by the high-speed dispersion was transferred to a three-roll grinder and ground once to obtain an organic slurry having a fineness of less than 1.5 μm.

### Example 14

70% of TbH metal powder, 26% of butyl carbitol, and 4% of ethyl cellulose were weighed by weight percentage, where the TbH metal powder had a particle size D50 of 1.8 μm.

The butyl carbitol and the ethyl cellulose were sequentially added into a mixer and stirred at a constant temperature of 25° C. and a speed of 1000 r/min for 15 minutes to obtain a uniform and non-flocculent organic carrier.

The TbH metal powder and the prepared organic carrier were added into a vacuum high-speed disperser and dispersed at a high speed of 2200 r/min for 30 minutes to preliminarily prepare an organic slurry; and then the organic slurry obtained by the high-speed dispersion was transferred to a three-roll grinder and ground once to obtain an organic slurry having a fineness of less than 2.3 μm.

### Example 15

70% of Tb₇₀Ni₃₀ metal powder, 15% of butyl carbitol, 8% of DBE, 3% of ethyl cellulose, 2% of butyl acetate, 1% of organosilicon, and 1% of acrylate were weighed by weight percentage, where the metal powder had a particle size D50 of 1.82 μm.

The butyl carbitol, DBE, ethyl cellulose, butyl acetate, organosilicon, and acrylate were sequentially added into a mixer and stirred at a constant temperature of 25° C. and a speed of 1200 r/min for 15 minutes to obtain a uniform and non-flocculent organic carrier.

The Tb₇₀Ni₃₀ metal powder and the prepared organic carrier were added into a vacuum high-speed disperser and dispersed at a high speed of 3000 r/min for 60 minutes to preliminarily prepare an organic slurry; and then the organic slurry obtained by the high-speed dispersion was transferred to a three-roll grinder and ground once to obtain an organic slurry having a fineness of less than 2.5 μm.

### Example 16

70% of DyO metal powder, 23% of butyl carbitol acetate, 1.5% of polyvinylidene fluoride, 0.5% of polyester resin, 1% of modified polyurethane polymer, 1% of butyl acetate, 1% of polyethylene amide, 1% of organosilicon, and 1% of modified acrylic acid were weighed by weight percentage, where the metal powder had a particle size D50 of 1.97 μm.

The butyl carbitol acetate, polyvinylidene fluoride, polyester resin, modified polyurethane polymer, butyl acetate, polyethylene amide, organosilicon, and modified acrylic acid were sequentially added into a mixer and stirred at a constant temperature of 60° C. and a speed of 1200 r/min for 6 hours to obtain a uniform and non-flocculent organic carrier.

The DyO metal powder and the prepared organic carrier were added into a vacuum high-speed disperser and dispersed at a high speed of 2300 r/min for 30 minutes to preliminarily prepare an organic slurry; and then the organic slurry obtained by the high-speed dispersion was transferred to a three-roll grinder and ground twice to obtain an organic slurry having a fineness of less than 2.4 μm.

### Example 17

30% of DyH+40% of TbH metal powders, 22.5% of propylene glycol phenyl ether, 3% of polyester resin, 2% of polyethylene glycol, and 2.5% of organosilicon were weighed by weight percentage, where the metal powders had particle sizes D50 of 1.67 μm and 1.88 μm, respectively.

The propylene glycol phenyl ether, polyester resin, polyethylene glycol, and organosilicon were sequentially added into a mixer and stirred at a constant temperature of 70° C. and a speed of 1200 r/min for 5 hours to obtain a uniform and non-flocculent organic carrier.

The 30% of DyH+40% of TbH metal powders and the prepared organic carrier were added into a vacuum high-speed disperser and dispersed at a high speed of 2300 r/min for 30 minutes to preliminarily prepare an organic slurry; and then the organic slurry obtained by the high-speed dispersion was transferred to a three-roll grinder and ground twice to obtain an organic slurry having a fineness of less than 2.5 μm.

### Example 18

70% of Dy metal powder, 23% of N-methyl pyrrolidone, 3% of polyvinyl butyral, 3% of polyethylene glycol, and 1% of acrylate were weighed by weight percentage, where the Dy metal powder had a particle size D50 of 1.56 μm.

The N-methyl pyrrolidone, polyvinyl butyral, polyethylene glycol, and polyacrylic acid were sequentially added into a mixer and stirred at a constant temperature of 25° C. and a speed of 1200 r/min for 15 minutes to obtain a uniform and non-flocculent organic carrier.

The Dy metal powder and the prepared organic carrier were added into a vacuum high-speed disperser and dispersed at a high speed of 2300 r/min for 30 minutes to preliminarily prepare an organic slurry; and then the organic slurry obtained by the high-speed dispersion was transferred to a three-roll grinder and ground three times to obtain an organic slurry having a fineness of less than 1.5 μm.

### Example 19

70% of Pr₇₀Cu₁₅Al₁₅ metal powder, 10% of butyl carbitol, 13% of N-methyl pyrrolidone, 3% of polyurethane, 2% of polyethylene amide, 1% of polyacrylic acid, and 1% of acrylate were weighed by weight percentage, where the metal powder had a particle size D50 of 1.79 μm.

The butyl carbitol, N-methyl pyrrolidone, polyurethane, polyvinyl amide, polyacrylic acid, and acrylate were sequentially added into a mixer and stirred at a constant temperature of 25° C. and a speed of 1200 r/min for 15 minutes to obtain a uniform and non-flocculent organic carrier.

The Pr₇₀Cu₁₅Al₁₅ metal powder and the prepared organic carrier were added into a vacuum high-speed disperser and dispersed at a high speed of 3000 r/min for 60 minutes to preliminarily prepare an organic slurry; and then the organic slurry obtained by the high-speed dispersion was transferred to a three-roll grinder and ground twice to obtain an organic slurry having a fineness of less than 2.2 μm.

### Example 20

30% of DyH+40% of TbH metal powders, 23% of propylene glycol phenyl ether, 3% of polyester resin, 2% of polyethylene glycol, and 1% of organosilicon were weighed by weight percentage, where the metal powders had a particle size D50 of 1.96 μm.

The propylene glycol phenyl ether, polyester resin, polyethylene glycol, and organosilicon were sequentially added into a mixer and stirred at a constant temperature of 25° C. and a speed of 1200 r/min for 15 minutes to obtain a uniform and non-flocculent organic carrier.

The 30% of DyH+40% of TbH metal powders and the prepared organic carrier were added into a vacuum high-speed disperser and dispersed at a high speed of 2300 r/min for 30 minutes to preliminarily prepare an organic slurry; and then the organic slurry obtained by the high-speed dispersion was transferred to a three-roll grinder and ground three times to obtain an organic slurry having a fineness of less than 2.3 μm.

### Example 21

70% of Tb₇₀Ni₃₀ metal powder, 15% of butyl carbitol, 8% of N-methyl pyrrolidone, 3% of polyurethane, 2% of polyethylene amide, and 2% of polyacrylic acid were weighed by weight percentage, where the metal powder had a particle size D50 of 1.91 μm.

The butyl carbitol, N-methyl pyrrolidone, polyurethane, polyethylene amide, and polyacrylic acid were sequentially added into a mixer and stirred at a constant temperature of 25° C. and a speed of 1200 r/min for 15 minutes to obtain a uniform and non-flocculent organic carrier.

The Tb₇₀Ni₃₀ metal powder and the prepared organic carrier were added into a vacuum high-speed disperser and dispersed at a high speed of 3000 r/min for 60 minutes to preliminarily prepare an organic slurry; and then the organic slurry obtained by the high-speed dispersion was transferred to a three-roll grinder and ground twice to obtain an organic slurry having a fineness of less than 2.5 μm.

### Example 22

70% of Dy metal powder, 21% of N-methyl pyrrolidone, 3% of polyvinyl butyral, 5% of polyethylene glycol, 0.5% of organosilicon, and 0.5% of polyacrylic acid were weighed by weight percentage, where the Dy metal powder had a particle size D50 of 1.85 μm.

The N-methyl pyrrolidone, polyvinyl butyral, polyethylene glycol, organosilicon, and polyacrylic acid were sequentially added into a mixer and stirred at a constant temperature of 25° C. and a speed of 1200 r/min for 15 minutes to obtain a uniform and non-flocculent organic carrier.

The Dy metal powder and the prepared organic carrier were added into a vacuum high-speed disperser and dispersed at a high speed of 2300 r/min for 30 minutes to preliminarily prepare an organic slurry; and then the organic slurry obtained by the high-speed dispersion was transferred to a three-roll grinder and ground twice to obtain an organic slurry having a fineness of less than 2.4 μm.

### Example 23

40% of Tb₈₀Cu₁₅Al₅+30% of Pr₇₀Cu₁₅Al₁₅ metal powders, 23% of butyl carbitol acetate, 3% of polyvinylidene fluoride, 1.5% of butyl acetate, 0.5% of polyethylene glycol, and 2% of organosilicon were weighed by weight percentage, where the metal powders had a particle size D50 of 1.97 μm.

The butyl carbitol acetate, polyvinylidene fluoride, butyl acetate, polyethylene glycol, and organosilicon were sequentially added into a mixer and stirred at a constant temperature of 40° C. and a speed of 1200 r/min for 40 minutes to obtain a uniform and non-flocculent organic carrier.

The Tb₈₀Cu₁₅Al₅ and Pr₇₀Cu₁₅Al₁₅ metal powders and the prepared organic carrier were added into a vacuum high-speed disperser and dispersed at a high speed of 3500 r/min for 60 minutes to preliminarily prepare an organic slurry; and then the organic slurry obtained by the high-speed dispersion was transferred to a three-roll grinder and ground once to obtain an organic slurry having a fineness of less than 2.4 μm.

### Example 24

70% of Tb₈₀Cu₁₅Al₅ metal powder, 23% of N-methyl pyrrolidone, 3% of polyvinyl butyral, 2% of polyethylene glycol, and 2% of organosilicon were weighed by weight percentage, where the metal powder had a particle size D50 of 1.69 μm.

The N-methyl pyrrolidone, polyvinyl butyral, polyethylene glycol, and organosilicon were sequentially added into a mixer and stirred at a constant temperature of 25° C. and a speed of 1200 r/min for 15 minutes to obtain a uniform and non-flocculent organic carrier.

The Tb₈₀Cu₁₅Al₅ metal powder and the prepared organic carrier were added into a vacuum high-speed disperser and dispersed at a high speed of 3000 r/min for 60 minutes to preliminarily prepare an organic slurry; and then the organic slurry obtained by the high-speed dispersion was transferred to a three-roll grinder and ground once to obtain an organic slurry having a fineness of less than 2.3 μm.

### Example 25

70% of DyO metal powder, 23% of butyl carbitol acetate, 1.5% of polyvinylidene fluoride, 1.5% of polyester resin, 2% of butyl acetate, and 2% of organosilicon were weighed by weight percentage, where the metal powder had a particle size D50 of 1.93 μm.

The butyl carbitol acetate, polyvinylidene fluoride, polyester resin, butyl acetate, and organosilicon were sequentially added into a mixer and stirred at a constant temperature of 40° C. and a speed of 1200 r/min for 40 minutes to obtain a uniform and non-flocculent organic carrier.

The DyO metal powder and the prepared organic carrier were added into a vacuum high-speed disperser and dispersed at a high speed of 2300 r/min for 30 minutes to preliminarily prepare an organic slurry; and then the organic slurry obtained by the high-speed dispersion was transferred to a three-roll grinder and ground twice to obtain an organic slurry having a fineness of less than 2.2 μm.

### Example 26

70% of Dy metal powder, 22% of N-methyl pyrrolidone, 3% of polyvinyl butyral, 4% of polyethylene glycol, 0.5% of organosilicon, and 0.5% of polyacrylic acid were weighed by weight percentage, where the Dy metal powder had a particle size D50 of 1.88 μm.

The N-methyl pyrrolidone, polyvinyl butyral, polyethylene glycol, organosilicon, and polyacrylic acid were sequentially added into a mixer and stirred at a constant temperature of 25° C. and a speed of 1200 r/min for 15 minutes to obtain a uniform and non-flocculent organic carrier.

The Dy metal powder and the prepared organic carrier were added into a vacuum high-speed disperser and dispersed at a high speed of 2300 r/min for 30 minutes to preliminarily prepare an organic slurry; and then the organic slurry obtained by the high-speed dispersion was transferred to a three-roll grinder and ground once to obtain an organic slurry having a fineness of less than 2.2 μm.

### Example 27

70% of Tb₇₀Ni₃₀ metal powder, 15% of butyl carbitol, 8% of N-methyl pyrrolidone, 1.5% of polyurethane, 1.5% of ethyl cellulose, 2% of polyethylene amide, and 2% of polyacrylic acid were weighed by weight percentage, where the metal powder had a particle size D50 of 1.77 μm.

The butyl carbitol, N-methyl pyrrolidone, polyurethane, ethyl cellulose, polyethylene amide, and polyacrylic acid were sequentially added into a mixer and stirred at a constant temperature of 25° C. and a speed of 1200 r/min for 15 minutes to obtain a uniform and non-flocculent organic carrier.

The Tb₇₀Ni₃₀ metal powder and the prepared organic carrier were added into a vacuum high-speed disperser and dispersed at a high speed of 3000 r/min for 60 minutes to preliminarily prepare an organic slurry; and then the organic slurry obtained by the high-speed dispersion was transferred to a three-roll grinder and ground once to obtain an organic slurry having a fineness of less than 2.3 μm.

### Example 28

70% of Tb₇₀Ni₃₀ metal powder, 23% of N-methyl pyrrolidone, 3% of ethyl cellulose, 1% of polyethylene amide, 0.5% of butyl acetate, 0.5% of modified polyurethane polymer, and 2% of organosilicon were weighed by weight percentage, where the metal powder had a particle size D50 of 1.47 μm.

The N-methyl pyrrolidone, ethyl cellulose, polyethylene amide, butyl acetate, and organosilicon were sequentially added into a mixer and stirred at a constant temperature of 25° C. and a speed of 1200 r/min for 15 minutes to obtain a uniform and non-flocculent organic carrier.

The Tb₇₀Ni₃₀ metal powder and the prepared organic carrier were added into a vacuum high-speed disperser and dispersed at a high speed of 3000 r/min for 50 minutes to preliminarily prepare an organic slurry; and then the organic slurry obtained by the high-speed dispersion was transferred to a three-roll grinder and ground twice to obtain an organic slurry having a fineness of less than 2.2 μm.

### Example 29

70% of TbF metal powder, 24% of butyl carbitol acetate, 4% of polyvinylidene fluoride, 1% of butyl acetate, and 1% of organosilicon were weighed by weight percentage, where the TbF metal powder had a particle size D50 of 1.68 μm.

The butyl carbitol acetate, polyvinylidene fluoride, butyl acetate, and organosilicon were sequentially added into a mixer and stirred at a constant temperature of 40° C. and a speed of 1200 r/min for 40 minutes to obtain a uniform and non-flocculent organic carrier.

The TbF metal powder and the prepared organic carrier were added into a vacuum high-speed disperser and dispersed at a high speed of 2300 r/min for 30 minutes to preliminarily prepare an organic slurry; and then the organic slurry obtained by the high-speed dispersion was transferred to a three-roll grinder and ground three times to obtain an organic slurry having a fineness of less than 1.5 μm.

### Example 30

70% of Tb₈₀Cu₁₅Al₅ metal powder, 20% of butyl carbitol, 3% of DBE, 3% of ethyl cellulose, 2% of polyethylene amide, and 2% of organosilicon were weighed by weight percentage, where the metal powder had a particle size D50 of 1.62 μm.

The butyl carbitol, DBE, ethyl cellulose, polyethylene amide, and organosilicon were sequentially added into a mixer and stirred at a constant temperature of 25° C. and a speed of 1200 r/min for 15 minutes to obtain a uniform and non-flocculent organic carrier.

The Tb₈₀Cu₁₅Al₅ metal powder and the prepared organic carrier were added into a vacuum high-speed disperser and dispersed at a high speed of 3000 r/min for 60 minutes to preliminarily prepare an organic slurry; and then the organic slurry obtained by the high-speed dispersion was transferred to a three-roll grinder and ground twice to obtain an organic slurry having a fineness of less than 1.7 μm.

### Example 31

70% of TbF metal powder, 25% of butyl carbitol acetate, 3% of polyvinylidene fluoride, 1% of polyethylene amide, and 1% of organosilicon were weighed by weight percentage, where the TbF metal powder had a particle size D50 of 1.58 μm.

The butyl carbitol acetate, polyvinylidene fluoride, polyethylene amide, and organosilicon were sequentially added into a mixer and stirred at a constant temperature of 40° C. and a speed of 1200 r/min for 40 minutes to obtain a uniform and non-flocculent organic carrier.

The TbF metal powder and the prepared organic carrier were added into a vacuum high-speed disperser and dispersed at a high speed of 2300 r/min for 30 minutes to preliminarily prepare an organic slurry; and then the organic slurry obtained by the high-speed dispersion was transferred to a three-roll grinder and ground three times to obtain an organic slurry having a fineness of less than 1.5 μm.

### Example 32

70% of Pr₇₀Cu₁₅Al₁₅ metal powder, 23% of N-methyl pyrrolidone, 1% of polyvinyl butyral, 2% of ethyl cellulose, 2% of polyethylene amide, and 2% of organosilicon were weighed by weight percentage, where the metal powder had a particle size D50 of 1.79 μm.

The N-methyl pyrrolidone, polyvinyl butyral, ethyl cellulose, polyethylene amide, and organosilicon were sequentially added into a mixer and stirred at a constant temperature of 25° C. and a speed of 1200 r/min for 20 minutes to obtain a uniform and non-flocculent organic carrier.

The Pr₇₀Cu₁₅Al₁₅ metal powder and the prepared organic carrier were added into a vacuum high-speed disperser and dispersed at a high speed of 3000 r/min for 50 minutes to preliminarily prepare an organic slurry; and then the organic slurry obtained by the high-speed dispersion was transferred to a three-roll grinder and ground once to obtain an organic slurry having a fineness of less than 2.3 μm.

### Example 33

70% of TbF metal powder, 22% of butyl carbitol acetate, 6% of polyvinylidene fluoride, 1% of polyethylene amide, and 1% of organosilicon were weighed by weight percentage, where the TbF metal powder had a particle size D50 of 1.89 μm.

The butyl carbitol acetate, polyvinylidene fluoride, polyethylene amide, and organosilicon were sequentially added into a mixer and stirred at a constant temperature of 40° C. and a speed of 1200 r/min for 40 minutes to obtain a uniform and non-flocculent organic carrier.

The TbF metal powder and the prepared organic carrier were added into a vacuum high-speed disperser and dispersed at a high speed of 2300 r/min for 30 minutes to preliminarily prepare an organic slurry; and then the organic slurry obtained by the high-speed dispersion was transferred to a three-roll grinder and ground once to obtain an organic slurry having a fineness of less than 2.5 μm.

### Example 34

70% of Tb₈₀Cu₁₅Al₅ metal powder, 23% of butyl carbitol acetate, 3% of polyvinylidene fluoride, 2% of polyethylene glycol, and 2% of organosilicon were weighed by weight percentage, where the metal powder had a particle size D50 of 1.94 μm.

The butyl carbitol acetate, polyvinylidene fluoride, polyethylene glycol, and organosilicon were sequentially added into a mixer and stirred at a constant temperature of 40° C. and a speed of 1200 r/min for 40 minutes to obtain a uniform and non-flocculent organic carrier.

The Tb₈₀Cu₁₅Al₅ metal powder and the prepared organic carrier were added into a vacuum high-speed disperser and dispersed at a high speed of 3000 r/min for 60 minutes to preliminarily prepare an organic slurry; and then the organic slurry obtained by the high-speed dispersion was transferred to a three-roll grinder and ground once to obtain an organic slurry having a fineness of less than 2.5 μm.

### Example 35

70% of Nd₆₀Fe₃₀Ga₁₀ metal powder, 23% of N-methyl pyrrolidone, 2% of ethyl cellulose, 1% of polyester resin, 1.5% of polyethylene amide, 0.5% of modified polyurethane polymer, and 2% of acrylate were weighed by weight percentage, where the metal powder had a particle size D50 of 1.85 μm.

The N-methyl pyrrolidone, ethyl cellulose, polyester resin, polyethylene amide, modified polyurethane polymer, and acrylate were sequentially added into a mixer and stirred at a constant temperature of 60° C. and a speed of 1200 r/min for 5 hours to obtain a uniform and non-flocculent organic carrier.

The Nd₆₀Fe₃₀Ga₁ metal powder and the prepared organic carrier were added into a vacuum high-speed disperser and dispersed at a high speed of 2500 r/min for 60 minutes to preliminarily prepare an organic slurry; and then the organic slurry obtained by the high-speed dispersion was transferred to a three-roll grinder and ground once to obtain an organic slurry having a fineness of less than 2.1 μm.

### Example 36

70% of Tb₇₀Ni₃₀ metal powder, 23% of butyl carbitol acetate, 3% of polyvinylidene fluoride, 2% of butyl acetate, and 2% of organosilicon were weighed by weight percentage, where the metal powder had a particle size D50 of 1.87 μm.

The butyl carbitol acetate, polyvinylidene fluoride, butyl acetate, and organosilicon were sequentially added into a mixer and stirred at a constant temperature of 40° C. and a speed of 1200 r/min for 40 minutes to obtain a uniform and non-flocculent organic carrier.

The Tb₇₀Ni₃₀ metal powder and the prepared organic carrier were added into a vacuum high-speed disperser and dispersed at a high speed of 3000 r/min for 60 minutes to preliminarily prepare an organic slurry; and then the organic slurry obtained by the high-speed dispersion was transferred to a three-roll grinder and ground twice to obtain an organic slurry having a fineness of less than 2.1 μm.

### Example 37

70% of TbF metal powder, 27.6% of butyl carbitol acetate, 0.4% of polyvinylidene fluoride, 0.5% of polyethylene amide, 0.5% of polyethylene glycol, and 1% of organosilicon were weighed by weight percentage, where the TbF metal powder had a particle size D50 of 1.82 μm.

The butyl carbitol acetate, polyvinylidene fluoride, polyethylene amide, polyethylene glycol, and organosilicon were sequentially added into a mixer and stirred at a constant temperature of 40° C. and a speed of 1200 r/min for 40 minutes to obtain a uniform and non-flocculent organic carrier. The TbF metal powder and the prepared organic carrier were added into a vacuum high-speed disperser and dispersed at a high speed of 2300 r/min for 30 minutes to preliminarily prepare an organic slurry; and then the organic slurry obtained by the high-speed dispersion was transferred to a three-roll grinder and ground three times to obtain an organic slurry having a fineness of less than 1.7 μm.

### Example 38

70% of DyO metal powder, 10% of butyl carbitol, 13% of DBE, 3% of ethyl cellulose, 2% of polyvinyl pyrrolidone, and 2% of polyacrylic acid were weighed by weight percentage, where the metal powder had a particle size D50 of 1.98 μm.

The butyl carbitol, DBE, ethyl cellulose, polyvinyl pyrrolidone, and polyacrylic acid were sequentially added into a mixer and stirred at a constant temperature of 25° C. and a speed of 1200 r/min for 15 minutes to obtain a uniform and non-flocculent organic carrier.

The DyO metal powder and the prepared organic carrier were added into a vacuum high-speed disperser and dispersed at a high speed of 2300 r/min for 30 minutes to preliminarily prepare an organic slurry; and then the organic slurry obtained by the high-speed dispersion was transferred to a three-roll grinder and ground three times to obtain an organic slurry having a fineness of less than 2.2 μm.

### Example 39

70% of Dy metal powder, 25% of N-methyl pyrrolidone, 3% of polyvinyl butyral, 1% of polyethylene glycol, and 1% of modified acrylic acid were weighed by weight percentage, where the Dy metal powder had a particle size D50 of 1.75 μm.

The N-methyl pyrrolidone, polyvinyl butyral, polyethylene glycol, and modified acrylic acid were sequentially added into a mixer and stirred at a constant temperature of 25° C. and a speed of 1200 r/min for 15 minutes to obtain a uniform and non-flocculent organic carrier.

The Dy metal powder and the prepared organic carrier were added into a vacuum high-speed disperser and dispersed at a high speed of 2300 r/min for 30 minutes to preliminarily prepare an organic slurry; and then the organic slurry obtained by the high-speed dispersion was transferred to a three-roll grinder and ground three times to obtain an organic slurry having a fineness of less than 1.7 μm.

### Example 40

70% of Tb₇₀Ni₃₀ metal powder, 23% of propylene glycol phenyl ether, 3% of polyester resin, 2% of polyethylene glycol, and 2% of organosilicon were weighed by weight percentage, where the metal powder had a particle size D50 of 1.88 μm.

The propylene glycol phenyl ether, polyester resin, polyethylene glycol, and organosilicon were sequentially added into a mixer and stirred at a constant temperature of 60° C. and a speed of 1200 r/min for 6 hours to obtain a uniform and non-flocculent organic carrier.

The Tb₇₀Ni₃₀ metal powder and the prepared organic carrier were added into a vacuum high-speed disperser and dispersed at a high speed of 3000 r/min for 60 minutes to preliminarily prepare an organic slurry; and then the organic slurry obtained by the high-speed dispersion was transferred to a three-roll grinder and ground twice to obtain an organic slurry having a fineness of less than 2.0 μm.

### Example 41

30% of DyH+40% of TbH metal powders, 24.5% of propylene glycol phenyl ether, 3% of polyester resin, 2% of polyethylene glycol, 0.5% of organosilicon, and 0.5% of polyacrylic acid were weighed by weight percentage, where the metal powders had particle sizes D50 of 1.73 μm and 1.69 μm, respectively.

The propylene glycol phenyl ether, polyester resin, polyethylene glycol, organosilicon, and polyacrylic acid were sequentially added into a mixer and stirred at a constant temperature of 70° C. and a speed of 1200 r/min for 5 hours to obtain a uniform and non-flocculent organic carrier.

The 30% of DyH+40% of TbH metal powders and the prepared organic carrier were added into a vacuum high-speed disperser and dispersed at a high speed of 2300 r/min for 30 minutes to preliminarily prepare an organic slurry; and then the organic slurry obtained by the high-speed dispersion was transferred to a three-roll grinder and ground twice to obtain an organic slurry having a fineness of less than 1.6 μm.

### Example 42

30% of DyH+40% of TbH metal powders, 25% of propylene glycol phenyl ether, 3% of polyester resin, and 2% of polyethylene glycol were weighed by weight percentage, where the metal powders had a particle size D50 of 1.96 μm.

The propylene glycol phenyl ether, polyester resin, and polyethylene glycol were sequentially added into a mixer and stirred at a constant temperature of 60° C. and a speed of 1200 r/min for 6 hours to obtain a uniform and non-flocculent organic carrier.

The 30% of DyH+40% of TbH metal powders and the prepared organic carrier were added into a vacuum high-speed disperser and dispersed at a high speed of 2300 r/min for 30 minutes to preliminarily prepare an organic slurry; and then the organic slurry obtained by the high-speed dispersion was transferred to a three-roll grinder and ground once to obtain an organic slurry having a fineness of less than 2.5 μm.

### Example 43

70% of Tb₇₀Ni₃₀ metal powder, 15% of butyl carbitol, 8% of DBE, 3% of ethyl cellulose, 1.5% of butyl acetate, 0.5% of polyethylene glycol, 1% of organosilicon, and 1% of acrylate were weighed by weight percentage, where the metal powder had a particle size D50 of 1.92 μm.

The butyl carbitol, DBE, ethyl cellulose, butyl acetate, polyethylene glycol, organosilicon, and acrylate were sequentially added into a mixer and stirred at a constant temperature of 25° C. and a speed of 1200 r/min for 25 minutes to obtain a uniform and non-flocculent organic carrier.

The Tb₇₀Ni₃₀ metal powder and the prepared organic carrier were added into a vacuum high-speed disperser and dispersed at a high speed of 3000 r/min for 60 minutes to preliminarily prepare an organic slurry; and then the organic slurry obtained by the high-speed dispersion was transferred to a three-roll grinder and ground once to obtain an organic slurry having a fineness of less than 2.4 μm.

### Example 44

70% of Nd₆₀Fe₃₀Ga₁₀ metal powder, 15% of butyl carbitol, 8% of DBE, 3% of ethyl cellulose, 2% of butyl acetate, 1% of organosilicon, and 1% of modified acrylic acid were weighed by weight percentage, where the metal powder had a particle size D50 of 1.66 μm.

The propylene glycol phenyl ether, polyester resin, polyethylene glycol, and organosilicon were sequentially added into a mixer and stirred at a constant temperature of 60° C. and a speed of 1200 r/min for 6 hours to obtain a uniform and non-flocculent organic carrier.

The Nd₆₀Fe₃₀Ga₁₀ metal powder and the prepared organic carrier were added into a vacuum high-speed disperser and dispersed at a high speed of 2500 r/min for 60 minutes to preliminarily prepare an organic slurry; and then the organic slurry obtained by the high-speed dispersion was transferred to a three-roll grinder and ground once to obtain an organic slurry having a fineness of less than 2.5 μm.

### Example 45

70% of Pr₇₀Cu₁₅Al₁₅ metal powder, 10% of butyl carbitol, 6% of N-methyl pyrrolidone, 7% of DBE, 3% of polyurethane, 2% of polyethylene amide, 1% of polyacrylic acid, and 1% of acrylate were weighed by weight percentage, where the metal powder had a particle size D50 of 2.0 μm.

The butyl carbitol, N-methyl pyrrolidone, DBE, polyurethane, polyvinyl amide, polyacrylic acid, and acrylate were sequentially added into a mixer and stirred at a constant temperature of 25° C. and a speed of 1200 r/min for 15 minutes to obtain a uniform and non-flocculent organic carrier.

The Pr₇₀Cu₁₅Al₁₅ metal powder and the prepared organic carrier were added into a vacuum high-speed disperser and dispersed at a high speed of 3000 r/min for 60 minutes to preliminarily prepare an organic slurry; and then the organic slurry obtained by the high-speed dispersion was transferred to a three-roll grinder and ground twice to obtain an organic slurry having a fineness of less than 2.1 μm.

### Example 46

40% of Tb₈₀Cu₁₅Al₅+30% of Pr₇₀Cu₁₅Al₁₅ metal powders, 15% of butyl carbitol, 8% of DBE, 3% of ethyl cellulose, 2% of butyl acetate, and 2% of acrylate were weighed by weight percentage, where the metal powders had particle sizes D50 of 1.62 μm and 1.65 μm.

The butyl carbitol acetate, polyvinylidene fluoride, butyl acetate, polyethylene glycol, and organosilicon were sequentially added into a mixer and stirred at a constant temperature of 40° C. and a speed of 1200 r/min for 40 minutes to obtain a uniform and non-flocculent organic carrier.

The Tb₈₀Cu₁₅Al₅ and Pr₇₀Cu₁₅Al₁₅ metal powders and the prepared organic carrier were added into a vacuum high-speed disperser and dispersed at a high speed of 3500 r/min for 60 minutes to preliminarily prepare an organic slurry; and then the organic slurry obtained by the high-speed dispersion was transferred to a three-roll grinder and ground three times to obtain an organic slurry having a fineness of less than 1.8 μm.

### Example 47

70% of Pr₇₀Cu₁₅Al₁₅ metal powder, 23% of N-methyl pyrrolidone, 3% of polyvinyl butyral, 2% of butyl acetate, and 2% of organosilicon were weighed by weight percentage, where the metal powder had a particle size D50 of 1.96 μm.

The N-methyl pyrrolidone, polyvinyl butyral, polyvinyl amide, and organosilicon were sequentially added into a mixer and stirred at a constant temperature of 25° C. and a speed of 1200 r/min for 15 minutes to obtain a uniform and non-flocculent organic carrier.

The Pr₇₀Cu₁₅Al₁₅ metal powder and the prepared organic carrier were added into a vacuum high-speed disperser and dispersed at a high speed of 3000 r/min for 60 minutes to preliminarily prepare an organic slurry; and then the organic slurry obtained by the high-speed dispersion was transferred to a three-roll grinder and ground once to obtain an organic slurry having a fineness of less than 2.5 μm.

### Example 48

40% of Tb₈₀Cu₁₅Al₅+30% of Pr₇₀Cu₁₅Al₁₅ metal powders, 15% of butyl carbitol, 8% of N-methyl pyrrolidone, 3% of polyurethane, 2% of polyethylene amide, and 2% of polyacrylic acid were weighed by weight percentage, where the metal powders had particle sizes D50 of 1.86 μm and 1.83 μm, respectively.

The butyl carbitol, N-methyl pyrrolidone, polyurethane, polyethylene amide, and polyacrylic acid were sequentially added into a mixer and stirred at a constant temperature of 25° C. and a speed of 1200 r/min for 15 minutes to obtain a uniform and non-flocculent organic carrier.

The Tb₈₀Cu₁₅A₁₅ and Pr₇₀Cu₁₅Al₁₅ metal powders and the prepared organic carrier were added into a vacuum high-speed disperser and dispersed at a high speed of 3000 r/min for 60 minutes to preliminarily prepare an organic slurry; and then the organic slurry obtained by the high-speed dispersion was transferred to a three-roll grinder and ground once to obtain an organic slurry having a fineness of less than 2.3 μm.

### Example 49

70% of Pr₇₀Cu₁₅Al₁₅ metal powder, 23% of N-methyl pyrrolidone, 1% of polyvinyl butyral, 1% of ethyl cellulose, 1% of polyurethane, 2% of polyethylene amide, and 2% of organosilicon were weighed by weight percentage, where the metal powder had a particle size D50 of 1.87 μm.

The N-methyl pyrrolidone, polyvinyl butyral, ethyl cellulose, polyurethane, polyethylene amide, and organosilicon were sequentially added into a mixer and stirred at a constant temperature of 25° C. and a speed of 1200 r/min for 15 minutes to obtain a uniform and non-flocculent organic carrier.

The Pr₇₀Cu₁₅Al₁₅ metal powder and the prepared organic carrier were added into a vacuum high-speed disperser and dispersed at a high speed of 3000 r/min for 60 minutes to preliminarily prepare an organic slurry; and then the organic slurry obtained by the high-speed dispersion was transferred to a three-roll grinder and ground twice to obtain an organic slurry having a fineness of less than 2.3 μm.

### Example 50

70% of TbF metal powder, 27% of butyl carbitol acetate, 1% of polyvinylidene fluoride, 1% of polyvinyl pyrrolidone, and 1% of organosilicon were weighed by weight percentage, where the TbF metal powder had a particle size D50 of 1.73 μm.

The butyl carbitol acetate, polyvinylidene fluoride, polyvinyl pyrrolidone, and organosilicon were sequentially added into a mixer and stirred at a constant temperature of 40° C. and a speed of 1200 r/min for 40 minutes to obtain a uniform and non-flocculent organic carrier.

The TbF metal powder and the prepared organic carrier were added into a vacuum high-speed disperser and dispersed at a high speed of 2300 r/min for 30 minutes to preliminarily prepare an organic slurry; and then the organic slurry obtained by the high-speed dispersion was transferred to a three-roll grinder and ground three times to obtain an organic slurry having a fineness of less than 1.7 μm.

### Example 51

70% of Dy metal powder, 26% of N-methyl pyrrolidone, 3% of polyvinyl butyral, and 1% of polyacrylic acid were weighed by weight percentage, where the Dy metal powder had a particle size D50 of 1.94 μm.

The N-methyl pyrrolidone, polyvinyl butyral, and polyacrylic acid were sequentially added into a mixer and stirred at a constant temperature of 25° C. and a speed of 1200 r/min for 15 minutes to obtain a uniform and non-flocculent organic carrier.

The Dy metal powder and the prepared organic carrier were added into a vacuum high-speed disperser and dispersed at a high speed of 2300 r/min for 30 minutes to preliminarily prepare an organic slurry; and then the organic slurry obtained by the high-speed dispersion was transferred to a three-roll grinder and ground twice to obtain an organic slurry having a fineness of less than 2.3 μm.

### Example 52

70% of TbF metal powder, 26% of butyl carbitol acetate, 2% of polyvinylidene fluoride, 1% of modified polyurethane polymer, and 1% of organosilicon were weighed by weight percentage, where the TbF metal powder had a particle size D50 of 1.6 μm.

The butyl carbitol acetate, polyvinylidene fluoride, modified polyurethane polymer, and organosilicon were sequentially added into a mixer and stirred at a constant temperature of 40° C. and a speed of 1200 r/min for 40 minutes to obtain a uniform and non-flocculent organic carrier.

The TbF metal powder and the prepared organic carrier were added into a vacuum high-speed disperser and dispersed at a high speed of 2300 r/min for 30 minutes to preliminarily prepare an organic slurry; and then the organic slurry obtained by the high-speed dispersion was transferred to a three-roll grinder and ground three times to obtain an organic slurry having a fineness of less than 1.6 μm.

### Example 53

50% of TbH metal powder, 44% of butyl carbitol, and 6% of ethyl cellulose were weighed by weight percentage, where the TbH metal powder had a particle size D50 of 1.8 μm.

The butyl carbitol and the ethyl cellulose were sequentially added into a mixer and stirred at a constant temperature of 25° C. and a speed of 1000 r/min for 15 minutes to obtain a uniform and non-flocculent organic carrier.

The TbH metal powder and the prepared organic carrier were added into a vacuum high-speed disperser and dispersed at a high speed of 1000 r/min for 15 minutes to preliminarily prepare an organic slurry; and then the organic slurry obtained by the high-speed dispersion was transferred to a three-roll grinder and ground once to obtain an organic slurry having a fineness of less than 2.5 μm.

### Example 54

70% of DyO metal powder, 23% of butyl carbitol acetate, 3% of polyvinylidene fluoride, 2% of butyl acetate, 1% of organosilicon, and 1% of acrylate were weighed by weight percentage, where the metal powder had a particle size D50 of 1.63 μm.

The butyl carbitol acetate, polyvinylidene fluoride, butyl acetate, organosilicon, and acrylate were sequentially added into a mixer and stirred at a constant temperature of 40° C. and a speed of 1200 r/min for 40 minutes to obtain a uniform and non-flocculent organic carrier.

The DyO metal powder and the prepared organic carrier were added into a vacuum high-speed disperser and dispersed at a high speed of 2000 r/min for 30 minutes to preliminarily prepare an organic slurry; and then the organic slurry obtained by the high-speed dispersion was transferred to a three-roll grinder and ground once to obtain an organic slurry having a fineness of less than 1.9 μm.

### Example 55

30% of DyH+40% of TbH metal powders, 23% of propylene glycol phenyl ether, 3% of polyester resin, 2% of polyethylene glycol, and 2% of organosilicon were weighed by weight percentage, where the metal powders had a particle size D50 of 1.81 μm.

The propylene glycol phenyl ether, polyester resin, polyethylene glycol, and organosilicon were sequentially added into a mixer and stirred at a constant temperature of 60° C. and a speed of 1200 r/min for 5 hours to obtain a uniform and non-flocculent organic carrier.

The 30% of DyH+40% of TbH metal powders and the prepared organic carrier were added into a vacuum high-speed disperser and dispersed at a high speed of 2300 r/min for 40 minutes to preliminarily prepare an organic slurry; and then the organic slurry obtained by the high-speed dispersion was transferred to a three-roll grinder and ground twice to obtain an organic slurry having a fineness of less than 2.3 μm.

### Example 56

70% of Dy metal powder, 24% of N-methyl pyrrolidone, 3% of polyvinyl butyral, 2% of polyethylene glycol, and 1% of organosilicon were weighed by weight percentage, where the Dy metal powder had a particle size D50 of 1.63 μm.

The N-methyl pyrrolidone, polyvinyl butyral, polyethylene glycol, and organosilicon were sequentially added into a mixer and stirred at a constant temperature of 25° C. and a speed of 800 r/min for 20 minutes to obtain a uniform and non-flocculent organic carrier.

The Dy metal powder and the prepared organic carrier were added into a vacuum high-speed disperser and dispersed at a high speed of 2300 r/min for 30 minutes to preliminarily prepare an organic slurry; and then the organic slurry obtained by the high-speed dispersion was transferred to a three-roll grinder and ground three times to obtain an organic slurry having a fineness of less than 1.7 μm.

### Example 57

70% of Pr₇₀Cu₁₅Al₁₅ metal powder, 23% of butyl carbitol acetate, 3% of polyvinylidene fluoride, 2% of butyl acetate, and 2% of organosilicon were weighed by weight percentage, where the metal powder had a particle size D50 of 1.99 μm.

The butyl carbitol acetate, polyvinylidene fluoride, butyl acetate, and organosilicon were sequentially added into a mixer and stirred at a constant temperature of 40° C. and a speed of 1200 r/min for 30 minutes to obtain a uniform and non-flocculent organic carrier.

The Pr₇₀Cu₁₅Al₁₅ metal powder and the prepared organic carrier were added into a vacuum high-speed disperser and dispersed at a high speed of 2200 r/min for 30 minutes to preliminarily prepare an organic slurry; and then the organic slurry obtained by the high-speed dispersion was transferred to a three-roll grinder and ground once to obtain an organic slurry having a fineness of less than 2.6 μm.

### Example 58

70% of DyO metal powder, 23% of butyl carbitol acetate, 1.5% of polyvinylidene fluoride, 1.5% of polyester resin, 1.5% of butyl acetate, 0.5% of polyethylene amide, and 2% of organosilicon were weighed by weight percentage, where the metal powder had a particle size D50 of 1.93 μm.

The butyl carbitol acetate, polyvinylidene fluoride, polyester resin, butyl acetate, polyethylene amide, and organosilicon were sequentially added into a mixer and stirred at a constant temperature of 70° C. and a speed of 1200 r/min for 6 hours to obtain a uniform and non-flocculent organic carrier.

The DyO metal powder and the prepared organic carrier were added into a vacuum high-speed disperser and dispersed at a high speed of 3500 r/min for 40 minutes to preliminarily prepare an organic slurry; and then the organic slurry obtained by the high-speed dispersion was transferred to a three-roll grinder and ground once to obtain an organic slurry having a fineness of less than 2.5 μm.

### Example 59

30% of DyH+40% of TbH metal powders, 24.5% of propylene glycol phenyl ether, 3% of polyester resin, 2% of polyethylene glycol, and 0.5% of organosilicon were weighed by weight percentage, where the metal powders had particle sizes D50 of 1.78 μm and 1.77 μm, respectively.

The propylene glycol phenyl ether, polyester resin, polyethylene glycol, and organosilicon were sequentially added into a mixer and stirred at a constant temperature of 60° C. and a speed of 1200 r/min for 60 minutes to obtain a uniform and non-flocculent organic carrier.

The 30% of DyH+40% of TbH metal powders and the prepared organic carrier were added into a vacuum high-speed disperser and dispersed at a high speed of 3000 r/min for 30 minutes to preliminarily prepare an organic slurry; and then the organic slurry obtained by the high-speed dispersion was transferred to a three-roll grinder and ground twice to obtain an organic slurry having a fineness of less than 2.0 μm.

### Example 60

70% of DyO metal powder, 10% of butyl carbitol, 13% of N-methyl pyrrolidone, 3% of polyurethane, 2% of polyethylene amide, 1% of acrylate, and 1% of polyacrylic acid were weighed by weight percentage, where the metal powder had a particle size D50 of 1.97 μm.

The butyl carbitol, N-methyl pyrrolidone, polyurethane, polyethylene amide, acrylate, and polyacrylic acid were sequentially added into a mixer and stirred at a constant temperature of 40° C. and a speed of 1000 r/min for 30 minutes to obtain a uniform and non-flocculent organic carrier.

The DyO metal powder and the prepared organic carrier were added into a vacuum high-speed disperser and dispersed at a high speed of 2500 r/min for 30 minutes to preliminarily prepare an organic slurry; and then the organic slurry obtained by the high-speed dispersion was transferred to a three-roll grinder and ground once to obtain an organic slurry having a fineness of less than 2.4 μm.

### Example 61

40% of Tb₈₀Cu₁₅Al₅+30% of Pr₇₀Cu₁₅Al₁₅ metal powders, 23% of butyl carbitol acetate, 1.5% of polyvinylidene fluoride, 1.5% of ethyl cellulose, 2% of butyl acetate, and 2% of organosilicon were weighed by weight percentage, where the metal powders had particle sizes of 1.75 μm and 1.92 μm, respectively.

The butyl carbitol acetate, polyvinylidene fluoride, ethyl cellulose, butyl acetate, and organosilicon were sequentially added into a mixer and stirred at a constant temperature of 50° C. and a speed of 600 r/min for 40 minutes to obtain a uniform and non-flocculent organic carrier.

The Tb₈₀Cu₁₅A₁₅ and Pr₇₀Cu₁₅Al₁₅ metal powders and the prepared organic carrier were added into a vacuum high-speed disperser and dispersed at a high speed of 2000 r/min for 40 minutes to preliminarily prepare an organic slurry; and then the organic slurry obtained by the high-speed dispersion was transferred to a three-roll grinder and ground once to obtain an organic slurry having a fineness of less than 2.2 μm.

### Example 62

90% of TbH metal powder, 8% of butyl carbitol, and 2% of ethyl cellulose were weighed by weight percentage, where the TbH metal powder had a particle size D50 of 1.83 μm.

The butyl carbitol and the ethyl cellulose were sequentially added into a mixer and stirred at a constant temperature of 25° C. and a speed of 600 r/min for 30 minutes to obtain a uniform and non-flocculent organic carrier.

The TbH metal powder and the prepared organic carrier were added into a vacuum high-speed disperser and dispersed at a high speed of 4000 r/min for 30 minutes to preliminarily prepare an organic slurry; and then the organic slurry obtained by the high-speed dispersion was transferred to a three-roll grinder and ground once to obtain an organic slurry having a fineness of less than 2.5 μm.

### Example 63

70% of Pr₇₀Cu₁₅Al₁₅ metal powder, 23% of propylene glycol phenyl ether, 3% of polyester resin, 2% of modified polyurethane polymer, and 2% of acrylate were weighed by weight percentage, where the metal powder had a particle size D50 of 1.62 μm.

The propylene glycol phenyl ether, polyester resin, modified polyurethane polymer, and acrylate were sequentially added into a mixer and stirred at a constant temperature of 70° C. and a speed of 1200 r/min for 6 hours to obtain a uniform and non-flocculent organic carrier.

The Pr₇₀Cu₁₅Al₁₅ metal powder and the prepared organic carrier were added into a vacuum high-speed disperser and dispersed at a high speed of 2300 r/min for 60 minutes to preliminarily prepare an organic slurry; and then the organic slurry obtained by the high-speed dispersion was transferred to a three-roll grinder and ground three times to obtain an organic slurry having a fineness of less than 1.8 μm.

### Example 64

70% of DyO metal powder, 10% of butyl carbitol, 8% of DBE, 5% of N-methyl pyrrolidone, 3% of polyurethane, 2% of polyethylene amide, and 2% of polyacrylic acid were weighed by weight percentage, where the metal powder had a particle size D50 of 1.95 μm. The butyl carbitol, DBE, N-methyl pyrrolidone, polyurethane, polyethylene amide, and polyacrylic acid were sequentially added into a mixer and stirred at a constant temperature of 40° C. and a speed of 1000 r/min for 15 minutes to obtain a uniform and non-flocculent organic carrier.

The DyO metal powder and the prepared organic carrier were added into a vacuum high-speed disperser and dispersed at a high speed of 2200 r/min for 40 minutes to preliminarily prepare an organic slurry; and then the organic slurry obtained by the high-speed dispersion was transferred to a three-roll grinder and ground once to obtain an organic slurry having a fineness of less than 2.1 μm.

### Comparative Example 1

60% of Tb rare earth powder, 30.8% of anhydrous ethanol, 7.7% of phenolic resin, 1% of polyvinyl pyrrolidone, and 0.5% of organosilicon leveling agent were weighed by weight percentage, where the Tb rare earth powder had a particle size D50 of 1.89 μm;

The anhydrous ethanol, phenolic resin, polyvinyl pyrrolidone, and

organosilicon leveling agent were sequentially added into a mixer and stirred at a constant temperature of 25° C. and a speed of 800 r/min for 15 minutes to obtain a uniform and non-flocculent organic carrier;

The Tb rare earth powder and the prepared organic carrier were added into the mixer and stirred at a high speed of 1500 r/min for 30 minutes to prepare an organic slurry.

### Comparative Example 2

60% of Tb rare earth powder, 30.8% of acetone, 7.7% of phenolic resin, 1% of polyvinyl pyrrolidone, and 0.5% of organosilicon leveling agent were weighed by weight percentage, where the Tb rare earth powder had a particle size D50 of 1.73 μm;

The anhydrous ethanol, phenolic resin, polyvinyl pyrrolidone, and

organosilicon leveling agent were sequentially added into a mixer and stirred at a constant temperature of 25° C. and a speed of 800 r/min for 15 minutes to obtain a uniform and non-flocculent organic carrier;

The Tb rare earth powder and the prepared organic carrier were added into the mixer and stirred at a high speed of 1500 r/min for 30 minutes to prepare an organic slurry.

The fineness of the organic slurries prepared in Examples 1-8 and Comparative Examples 1 and 2 was tested with a scraper fineness meter, and the results were shown in Table 2. The fineness of the organic slurries prepared in Examples 1-8 was only 1.5-2.5 μm, showing that the powder particles in the organic slurries had good dispersion and did not agglomerate significantly. Compared to the original particle sizes of the powders, the fineness of the organic slurries prepared in Comparative Examples 1 and 2 significantly increased, showing that the powder particles were not effectively dispersed in the preparation process and a large number of particles aggregated in the organic slurries.

TABLE 2

| Serial | Fineness/ | Serial | Fineness/ | Serial | Fineness/ |
|---|---|---|---|---|---|
| number | μm | number | μm | number | μm |
| Example 1 | 2.3 | Example 23 | 2.4 | Example 45 | 2.1 |
| Example 2 | 2.2 | Example 24 | 2.3 | Example 46 | 1.8 |
| Example 3 | 1.9 | Example 25 | 2.2 | Example 47 | 2.5 |
| Example 4 | 2.3 | Example 26 | 2.2 | Example 48 | 2.3 |
| Example 5 | 2.5 | Example 27 | 2.3 | Example 49 | 2.3 |
| Example 6 | 1.8 | Example 28 | 2.2 | Example 50 | 1.7 |
| Example 7 | 2.5 | Example 29 | 1.5 | Example 51 | 2.3 |
| Example 8 | 2.5 | Example 30 | 1.7 | Example 52 | 1.6 |
| Example 9 | 2.5 | Example 31 | 1.5 | Example 53 | 2.5 |
| Example 10 | 1.8 | Example 32 | 2.3 | Example 54 | 1.9 |
| Example 11 | 2.4 | Example 33 | 1.6 | Example 55 | 2.3 |
| Example 12 | 1.7 | Example 34 | 2.6 | Example 56 | 1.7 |
| Example 13 | 1.5 | Example 35 | 2.1 | Example 57 | 2.6 |
| Example 14 | 2.3 | Example 36 | 2.1 | Example 58 | 2.5 |
| Example 15 | 2.6 | Example 37 | 1.9 | Example 59 | 2 |
| Example 16 | 2.4 | Example 38 | 2.2 | Example 60 | 2.4 |
| Example 17 | 2.5 | Example 39 | 2.3 | Example 61 | 2.2 |
| Example 18 | 1.5 | Example 40 | 2 | Example 62 | 2.8 |
| Example 19 | 2.2 | Example 41 | 1.6 | Example 63 | 1.8 |
| Example 20 | 2.3 | Example 42 | 2.1 | Example 64 | 2.1 |
| Example 21 | 2.5 | Example 43 | 2.4 | Comparative | 6.5 |
| | | | | Example 1 | |
| Example 22 | 2.4 | Example 44 | 2.6 | Comparative | 7 |
| | | | | Example 2 | |

The organic slurries prepared in Examples 1-64 and the organic slurries prepared in Comparative Examples 1 and 2 were aged at 60° C. for 48 hours. Significant settlement and stratification did not occur after the aging experiment of the organic slurries prepared in Examples 1-64, while significant stratification occurred after the aging experiment of the organic slurries prepared in Examples 1 and 2.

The organic slurries prepared in Examples 1-8 and Comparative Examples 1 and 2 were applied to surfaces of magnets by screen printing and dried at 120° C. for 15 minutes, then weight gains of the magnets were tested, and the results were shown in Table 3. The weight gains of the magnets during the screen printing of the organic slurries prepared in Examples 1-8 were stable, which was conducive to ensuring consistency in subsequent diffusion. The weight gains of the magnets during the screen printing of the organic slurries prepared in Comparative Examples 1 and 2 fluctuated greatly, making it difficult to ensure stability between batches.

TABLE 3

| Serial | Weight | | Serial | Weight | |
|---|---|---|---|---|---|
| number | gain/% | | number | gain/% | |
| Example 1 | Sample 1 | 0.84 | Example 6 | Sample 1 | 0.32 |
| | Sample 2 | 0.82 | | Sample 2 | 0.31 |
| | Sample 3 | 0.83 | | Sample 3 | 0.32 |
| | Sample 4 | 0.82 | | Sample 4 | 0.33 |
| | Sample 5 | 0.8 | | Sample 5 | 0.32 |
| Example 2 | Sample 1 | 0.51 | Example 7 | Sample 1 | 0.72 |
| | Sample 2 | 0.54 | | Sample 2 | 0.69 |
| | Sample 3 | 0.54 | | Sample 3 | 0.67 |
| | Sample 4 | 0.53 | | Sample 4 | 0.71 |
| | Sample 5 | 0.52 | | Sample 5 | 0.70 |
| Example 3 | Sample 1 | 0.62 | Example 8 | Sample 1 | 0.56 |
| | Sample 2 | 0.65 | | Sample 2 | 0.52 |
| | Sample 3 | 0.63 | | Sample 3 | 0.53 |
| | Sample 4 | 0.64 | | Sample 4 | 0.54 |
| | Sample 5 | 0.62 | | Sample 5 | 0.51 |
| Example 4 | Sample 1 | 0.52 | Comparative | Sample 1 | 0.16 |
| | Sample 2 | 0.52 | Example 1 | Sample 2 | 0.35 |
| | Sample 3 | 0.55 | | Sample 3 | 0.48 |
| | Sample 4 | 0.53 | | Sample 4 | 0.27 |
| | Sample 5 | 0.54 | | Sample 5 | 0.39 |
| Example 5 | Sample 1 | 0.13 | Comparative | Sample 1 | 0.33 |
| | Sample 2 | 0.15 | Example 2 | Sample 2 | 0.24 |
| | Sample 3 | 0.11 | | Sample 3 | 0.46 |
| | Sample 4 | 0.09 | | Sample 4 | 0.4 |
| | Sample 5 | 0.11 | | Sample 5 | 0.29 |

The embodiments of the present application aim to protect an organic slurry for neodymium iron boron screen printing and a preparation method, which have the following effects:

The prepared organic slurry for neodymium iron boron screen printing in the present application achieves high dispersibility and suspension stability by optimizing the organic carrier and dispersing agglomerated powder particles by virtue of strong mechanical actions of the vacuum high-speed disperser and the three-roll grinder through high-speed shearing and grinding. The prepared slurry has a fineness of less than 2.5 μm, a monthly sedimentation rate of less than 5%, and a consistency of weight gain of less than +5% during printing. The prepared slurry has excellent dispersibility and stability.

It should be understood that the above-mentioned specific implementations of the present application are merely used for illustrating or interpreting the principle of the present application, rather than limiting the present application. Therefore, any modifications, equivalent substitutions, improvements, and the like made without deviating from the spirit and scope of the present application shall fall within the scope of protection of the present application. Moreover, the appended claims of the present application are intended to cover all variations and modifications falling within the scope and boundary of the appended claims or within equivalent forms of the scope and boundary.

What is claimed is:

1. An organic slurry for neodymium iron boron screen printing, comprising a rare earth powder, an organic solvent, a resin, a dispersant, and/or a leveling agent, weight percentages of which are as follows:
rare earth powder 50%-90%;
organic solvent 8%-50%;
resin 0.4%-6%;
dispersant 0%-5%; and
leveling agent 0%-3%.

2. The organic slurry for neodymium iron boron screen printing according to claim 1, wherein the rare earth powder comprises one or two or more of a pure metal powder containing a heavy rare earth element, an alloy powder containing a heavy rare earth or light rare earth element, and a heavy rare earth powder of a hydride, a fluoride or an oxide containing heavy rare earth.

3. The organic slurry for neodymium iron boron screen printing according to claim 2, wherein the heavy rare earth element comprises one or two or more of Tb, Dy, Ho, and Gd; and
the alloy powder is ReₓM_{y} in percentage by mass, wherein Re is one or two or more of Tb, Dy, Ho, Gd, Pr, Nd, La, Ce, and Y; M is one or two or more of Ga, Cu, Al, Ni, and Fe; 60%≤x≤95%, and 5%≤y≤40%.

4. The organic slurry for neodymium iron boron screen printing according to claim 1, wherein the rare earth powder has a particle size D50<2 μm.

5. The organic slurry for neodymium iron boron screen printing according to claim 2, wherein the organic solvent comprises one or two or more of butyl carbitol, butyl carbitol acetate, N-methyl pyrrolidone, texanol, propylene glycol phenyl ether, propylene glycol methyl ether acetate, and DBE.

6. The organic slurry for neodymium iron boron screen printing according to claim 5, wherein the resin comprises one or two or more of polyvinylidene fluoride, nitrocellulose, ethyl cellulose, polyvinyl butyral, acrylic resin, polyester resin, and polyurethane.

7. The organic slurry for neodymium iron boron screen printing according to claim 6, wherein the dispersant comprises one or two or more of butyl acetate, modified polyurethane polymer, polyethylene glycol, polyvinyl pyrrolidone, and polyvinyl amide.

8. The organic slurry for neodymium iron boron screen printing according to claim 7, wherein the leveling agent comprises one or two or more of organosilicon, acrylate, modified acrylic acid, and polyacrylic acid.

9. The organic slurry for neodymium iron boron screen printing according to claim 8, wherein the weight percentage of each ingredient is as follows:
pure metal powder 60%-80%;
one or two or more of butyl carbitol, butyl carbitol acetate, and DBE 10%-30%;
one or two or more of ethyl cellulose, acrylic resin, and polyvinyl butyral 0.4%-5%;
one or two of polyethylene glycol and butyl acetate 0%-3%; and
one or more of acrylate, polyacrylic acid, and organosilicon 0%-1.5%.

10. The organic slurry for neodymium iron boron screen printing according to claim 8, wherein the weight percentage of each ingredient is as follows:
alloy powder 60%-80%;
one or two or more of butyl carbitol, propylene glycol phenyl ether, and DBE 10%-30%;
one or two or more of polyester resin, ethyl cellulose, and acrylic resin 0.4%-3%;
one or two of polyethylene amide and polyvinyl pyrrolidone 0%-3%; and
one or two of modified acrylic acid and acrylate 0%-1.5%.

11. The organic slurry for neodymium iron boron screen printing according to claim 8, wherein the weight percentage of each ingredient is as follows:
heavy rare earth powder 60%-80%;
one or two or more of butyl carbitol, butyl carbitol acetate, and propylene glycol phenyl ether 10%-30%;
one or two or more of polyvinyl butyral, ethyl cellulose, and polyurethane 0.4%-5%;
one or two of butyl acetate and polyethylene glycol 0%-3%; and
one or two of polyacrylic acid and acrylate 0%-1.5%.

12. A preparation method for the organic slurry for neodymium iron boron screen printing according to claim 1, comprising:
weighing a rare earth powder, an organic solvent, a resin, a dispersant, and/or a leveling agent by weight percentage;
sequentially adding the weighed organic solvent, resin, dispersant, and/or leveling agent into a mixer, stirring at a constant temperature of 20-70° C. and a speed of 600 r/min-1200 r/min for 0.1-6 hours, and then cooling to room temperature to obtain an organic carrier;
adding the organic carrier and the weighed rare earth powder into a vacuum high-speed disperser, and dispersing at a high speed of 1000 r/min-4000 r/min for 0.25-1 hour to obtain a crude organic slurry; and
transferring the crude organic slurry to a gap adjustable three-roll grinder, and grinding 1-3 times to obtain a fine organic slurry.
